(19) United States
(12) Patent Application Publication
(10) Pub. No.: US 2026/0361664 A1
(43) Pub. Date: Nov. 12, 2026

(54) METHOD AND SYSTEM FOR FEEDBACK AGGREGATION IN NON-TERRESTRIAL NETWORKS

(71) Applicant: Huawei Technologies Co., Ltd., Shenzhen (CN)

(72) Inventors: Shahram Mollahasani, Ottawa (CA); Amine Maaref, Ottawa (CA)

(21) Appl. No.: 19/733,419

(22) Filed: Jul. 7, 2026

Related U.S. Application Data
(63) Continuation of application No. PCT/CN2024/071038, filed on Jan. 8, 2024.

(51) Int. Cl. H04L 47/70; H04B 17/309; H04L 5/00

(52) U.S. Cl. CPC H04L 47/827; H04B 17/309; H04L 5/0098

(57) ABSTRACT

Methods and systems for the use of terrestrial network elements to provide aggregated messaging related to communications between non-terrestrial terminal devices and non-terrestrial base stations. In some cases, the aggregated communications deal with interference experienced by one or both of terrestrial and non-terrestrial terminal devices. In some cases, the aggregated communications can provide interpolation of reports received from terminal devices. In some cases, the aggregated communications relate to uplink data resource allocation.

### CROSS-REFERENCE TO RELATED APPLICATION

The present application is a continuation of international application No. PCT/CN2024/071038, filed on Jan. 8, 2024, and hereby incorporated by reference in its entirety.

### FIELD OF THE DISCLOSURE

The present disclosure relates to non-terrestrial network (NTN) communications systems, and in implementations relates to beam hopping and/or scheduling in NTN communications systems.

### BACKGROUND

Wireless communications system such as fourth generation (4G) system (for example, Long-Term Evolution (LTE) system), fifth generation (5G) system (for example, New Radio (NR) system) have been deployed to provide various types of applications, such as message, voice, video and other data.

In NR, non-terrestrial networks (NTNs) are developed, which may utilize spaceborne vehicles such as satellites (including low earth orbiting (LEO) satellites, medium earth orbiting (MEO) satellites, geostationary earth orbiting (GEO) satellites as well as highly elliptical orbiting (HEO) satellites), or airborne vehicles (also called high-altitude platform) such as drones, or aircraft as a base station or relay for communications between different devices.

Either the satellites or the drones in NTNs may move at a high-speed relative to devices such as user equipments (UEs) operating within the NTN, which is different from the scenario between UE and ground-based base station. In addition, the distance between the UE and the satellites or the drones is also much longer than the distance between UE and ground-based base station.

Accordingly, the solutions in NTNs, which may cooperate with terrestrial networks (TN), to provide communications with acceptable cost (such as power consumption, and or complexity) are desired.

In NTN communications, beam hopping is the ability of a non-terrestrial base station (BS) to allocate capacity momentarily according to demand. Specifically, beam hopping is a technique that dynamically switches the direction, shape, size and frequency of a beam, where a beam is a portion of the electromagnetic spectrum that is allocated to a specific area of the earth's surface.

Beam hopping (BH) can enhance the efficiency and flexibility of NTN communication systems in several ways. By using available bandwidth more effectively and avoiding interference, it can increase the capacity and throughput of the non-terrestrial base station, while reducing power consumption and thermal load. This not only enhances the quality of service and user experience, but also supports diverse applications and services. Moreover, beam hopping allows for adjusting beam power according to demand and link conditions, providing more reliable coverage and connectivity, and adapting to varying and unpredictable traffic patterns and requirements.

To realize these functions the system needs to successfully suppress the co-interference between beams and other networks and efficiently plan and allocate the bandwidth, power and other resources of each beam.

This background information is provided to reveal information believed by the applicant to be of possible relevance to the present disclosure. No admission is necessarily intended, nor should be construed that any of the preceding information constitutes prior art against the present disclosure.

### SUMMARY

According to at least a first aspect of the present disclosure, a method at a first network element, the first network element being a terrestrial network element, is provided. The method may include receiving first messages from terminal devices, and sending an aggregated message to a second network element, the aggregated message indicating one or both of a subset of the first messages and information derived from the first messages, where the second network element is a non-terrestrial network element.

In some implementations, each of the first messages may comprise interference measurements based on at least one of: a quality of a communications channel; and reference signals, wherein the aggregated message may comprise aggregated interference measurements.

In some implementations, the aggregated interference measurements indicates interference measurements from a subset of all the first messages.

In some implementations, the subset of all the first messages are from non-terrestrial network terminal devices.

In some implementations the method may further comprise removing outliers from the first messages.

In some implementations, the aggregated message may further include at least one of: an identifier of the first network element; an aggregated channel quality indicator (CQI); an aggregated rank indicator (RI); an aggregated precoding matrix indicator (PMI); an aggregated reference signal received power (RSRP) and reference signal received strength indicator (RSSI); an interference level; an interference source; an affected frequency band; a bandwidth; bandwidth part details; resource block details; an aggregation technique; or a temporal aggregation window.

In some implementations a subset of the first messages may include interference measurements based on at least one of the reference signals and a quality of a communications channel, as reported from terrestrial network terminal devices, and a further subset of the first messages may include interference measurements based on at least one of the reference signals and the quality of a communications channel, as reported from non-terrestrial network terminal devices, and wherein the aggregated message may include information from both the terrestrial network terminal devices and non-terrestrial network terminal devices.

In some implementations, the terminal devices may include terrestrial terminal devices served by the first network element; and wherein the aggregated message may include the interference measurements of the terrestrial terminal devices and at least one non-terrestrial terminal device served by the second network element.

In some implementations, the method may further comprise receiving second messages from one or more terminal devices, wherein the one or more terminal devices are served by the first network element; detecting a change in interference measurements based on the second messages; and providing a report to the second network element based on the change in interference measurements.

In some implementations, the method may further comprise receiving third messages from one or more terminal devices, wherein the one or more terminal devices may be served by the first network element, the one or more terminal devices comprising terrestrial terminal devices and the third messages including interference measurements from the one or more terrestrial terminal devices; and sending a second aggregated message to the second network element, the second aggregated message indicating a subset of the third messages.

In some implementations, each of the first messages may comprise an uplink scheduling request for non-terrestrial terminal devices, and wherein the aggregated message may comprise uplink control information (UCI) indicating the uplink scheduling requests.

In some implementations, the method may further comprise receiving scheduling information from the second network element, the scheduling information indicating an overall resource allocation; determining resource allocation for at least one of the non-terrestrial network terminal devices based on the overall resource allocation; and sending at least one scheduling grant using downlink control information (DCI) on a Physical Downlink Control Channel (PDCCH) to the at least one of the terminal devices.

In some implementations, creation of the aggregated message may comprise using interpolation on the first messages with respect to time and frequency.

In some implementations, the first messages may come from two classes of terminal devices, and wherein the interpolation may use curve-fitting when messages from a first class of terminal devices is missing or unreliable.

According to another aspect of the present disclosure, a first network element having a processor and a communications subsystem may be provided. The first network element may be configured to receive first messages from terminal devices; and send an aggregated message to a second network element, the aggregated message indicating one or both of a subset of the first messages and information derived from the first messages, wherein the first network element is a terrestrial network element and the second network element is a non-terrestrial network element.

In some implementations, each of the first messages may comprise interference measurements based on at least one of: a quality of a communications channel; and reference signals, wherein the aggregated message may comprise aggregated interference measurements.

In some implementations, the first network element may further be configured to remove outliers from the first messages.

In some implementations, the aggregated message may further include at least one of: an identifier of the first network element; an aggregated channel quality indicator (CQI); an aggregated rank indicator (RI); an aggregated precoding matrix indicator (PMI); an aggregated reference signal received power (RSRP) and reference signal received strength indicator (RSSI); an interference level; an interference source; an affected frequency band; a bandwidth; bandwidth part details; resource block details; an aggregation technique; or a temporal aggregation window.

In some implementations, a subset of the first messages may include interference measurements based on at least one of the reference signals and a quality of a communications channel, as reported from terrestrial network terminal devices, and a further subset of the first messages includes interference measurements based on at least one of the reference signals and the quality of a communications channel, as reported from non-terrestrial network terminal devices, and wherein the aggregated message includes information from both the terrestrial network terminal devices and non-terrestrial network terminal devices.

In some implementations, the terminal devices may include terrestrial terminal devices served by the first network element; and wherein the aggregated message may include the interference measurements of the terrestrial terminal devices and at least one non-terrestrial terminal device served by the second network element.

In some implementations, the first network element may further be configured to receive second messages from one or more terminal devices, wherein the one or more terminal devices are served by the first network element; detect a change in interference measurements based on the second messages; and provide a report to the second network element based on the change in interference measurements.

In some implementations, the first network element may further be configured to: receive third messages from one or more terminal devices, wherein the one or more terminal devices are served by the first network element, the one or more terminal devices comprising terrestrial terminal devices and the third messages including interference measurements from the one or more terrestrial terminal devices; and send a second aggregated message to the second network element, the second aggregated message indicating a subset of the third messages.

In some implementations, each of the first messages may comprise an uplink scheduling request for non-terrestrial terminal devices, and wherein the aggregated message may comprise uplink control information (UCI) indicating the uplink scheduling requests.

In some implementations, the first network element may further be configured to: receive scheduling information from the second network element, the scheduling information indicating an overall resource allocation; determine resource allocation for at least one of the NTN terminal devices based on the overall resource allocation; and send at least one scheduling grant to the at least one of the terminal devices.

In some implementations, creation of the aggregated message may comprise using interpolation on the first messages with respect to time and frequency.

In some implementations, the first messages may come from two classes of terminal devices, and wherein the interpolation may use curve-fitting when messages from a first class of terminal devices is missing or unreliable.

According to another aspect of the present disclosure, a non-transitory computer readable medium for storing instruction code may be provided. The instruction code, when executed by a processing device of a terrestrial network element, may cause the terrestrial network element to receive first messages from terminal devices; and send an aggregated message to a second network element, the aggregated message indicating a subset of the first messages, wherein the first network element is a terrestrial network element and the second network element is a non-terrestrial network element.

According to another aspect of the present disclosure, a method at a first network element, the first network element being a terminal device, may be provided. The method may include receiving a configuration message at the terminal device, the configuration message specifying a first node operating in one of a terrestrial network and a non-terrestrial network, receiving a reference signal from a second node operating in the other of the terrestrial network and the non-terrestrial network and sending feedback to the first node based on the received configuration message.

In some implementations, the first node is a network element and the second node is another network element.

In some implementations, the configuration message may be received from a terrestrial network element.

In some implementations, the configuration message may be received from a non-terrestrial network element.

In some implementations, the configuration message may provide at least one of: a frequency for sending the feedback; and a time for sending the feedback.

In some implementations, the configuration message may further specify to send scheduling information to the first node.

In another aspect, a terminal device having a processor; and a communications subsystem may be provided. The terminal device may be configured to: receive a configuration message at the terminal device, the configuration message specifying a first node operating in one of a terrestrial network and a non-terrestrial network; receive a reference signal from a second node operating in the other of the terrestrial network and the non-terrestrial network; and send feedback to the first node based on the received configuration message.

In some implementations, the configuration message may be received from a terrestrial network element.

In some implementations, the configuration message may be received from a non-terrestrial network element.

In some implementations, the configuration message may provide at least one of: a frequency for sending the feedback; and a time for sending the feedback.

In some implementations, the configuration message may further specify to send scheduling information to the first node.

In another aspect, a method at a first network element may be provided. The method may include sending a configuration message from the network element destined for a terminal device operating in one of a terrestrial network and a non-terrestrial network, the configuration message specifying a node to which to send feedback, the node operating in the other of the terrestrial network and the non-terrestrial network; and receiving feedback based on the configuration message.

In some implementations, the configuration message may be provided to the terminal device through a terrestrial network element, the terminal device being a non-terrestrial network terminal device.

In some implementations, the configuration message may be provided to the terminal device through a non-terrestrial network element, the terminal device being a terrestrial network terminal device.

In some implementations, the configuration message may provide at least one of: a frequency for sending the feedback; and a time for sending the feedback.

In some implementations, the configuration message may further specify to send scheduling information to the node.

In another aspect, a network element comprising a processor; and a communications subsystem may be provided. The network element may be configured to send a configuration message from the network element destined for a terminal device operating in one of a terrestrial network and a non-terrestrial network, the configuration message specifying a node operating in the other of the terrestrial network and the non-terrestrial network to which to send feedback; and receive feedback based on the configuration message.

In some implementations, the configuration message may be provided to the terminal device through a terrestrial network element, the terminal device being a non-terrestrial network terminal device.

In some implementations, the configuration message may be provided to the terminal device through a non-terrestrial network element, the terminal device being a terrestrial network terminal device.

In some implementations, the configuration message may provide at least one of: a frequency for sending the feedback; and a time for sending the feedback.

In some implementations, the configuration message may further specify to send scheduling information to the node.

In some aspects of the present disclosure, there is provided an apparatus/chipset system comprising means (e.g., at least one processor) to implement a method implemented by (or at) a UE of the present disclosure. The apparatus/chipset system may be the UE (that is, a terminal device) or a module/component in the UE. In details, the at least one processor may execute instructions stored in a computer-readable medium to implement the method.

In some aspects of the present disclosure, there is provided an apparatus/chipset system comprising means (e.g., at least one processor) to implement the method implemented by (or at) a network device (e.g., base station) of the present disclosure. The apparatus/chipset system may be the network device or a module/component in the network device. In details, the at least one processor may execute instructions stored in a computer-readable medium to implement the method.

In some aspects of the present disclosure, there is provided a system comprising at least one of an apparatus in (or at) a UE of the present disclosure, or an apparatus in (or at) a network device of the present disclosure.

In some aspects of the present disclosure, there is provided a method performed by a system comprising at least one of an apparatus in (or at) a UE of the present disclosure, and an apparatus in (or at) a network device of the present disclosure.

In some aspects of the present disclosure, there is provided a computer program comprising instructions. The instructions, when executed by a processor, may cause the processor to implement a method of the present disclosure.

In some aspects of the present disclosure, there is provided a non-transitory computer-readable medium storing instructions, the instructions, when executed by a processor, may cause the processor to implement a method of the present disclosure.

### BRIEF DESCRIPTION OF THE DRAWINGS

The present disclosure will be better understood having regard to the drawings in which:

FIG. 1 is a block diagram showing a simplified communications system.

FIG. 2 is a block diagram showing a more detailed communications system than that of FIG. 1.

FIG. 3 is a block diagram showing communications between three apparatuses.

FIG. 4 is a block diagram showing various modules within a computing device.

FIG. 5 is a block diagram showing an example network.

FIG. 6 is a block diagram showing a further example network.

FIG. 7 is a block diagram showing an NTN communications system with three beams.

FIG. 8 is a block diagram showing the changing of a beam pattern in two time periods.

FIG. 9 is a block diagram showing a plurality of beams from a non-terrestrial (NT) BS over a geographic area.

FIG. 10 is a dataflow diagram showing the reconfiguration of a beam hopping pattern based on aggregated feedback from a terrestrial network element.

FIG. 11 is a dataflow diagram showing the updating of a beam hopping pattern at non-terrestrial user equipments.

FIG. 12 is a dataflow diagram showing typical interference measurements at an NTN system.

FIG. 13 is a dataflow diagram showing aggregation of interference measurements at a network element and provision of aggregated reports to a NT BS.

FIG. 14 is a dataflow diagram showing aggregation of interference measurements at a network element from both terrestrial and non-terrestrial terminal devices and provision of a single aggregated report to a NT BS.

FIG. 15 is a dataflow diagram showing aggregation of interference measurements at a network element and the providing of a report when a sudden change in interference occurs.

FIG. 16 is a dataflow diagram showing aggregation of interference measurements at a network element and provision of aggregated reports for different frequencies to an NT BS.

FIG. 17 is a dataflow diagram showing allocation of uplink resources in an NT system.

FIG. 18 is a dataflow diagram showing the use of a terrestrial network element during allocation of uplink resources.

### DETAILED DESCRIPTION OF ILLUSTRATIVE EMBODIMENTS

To assist in understanding the present disclosure, examples of wireless communication systems and devices are described below.

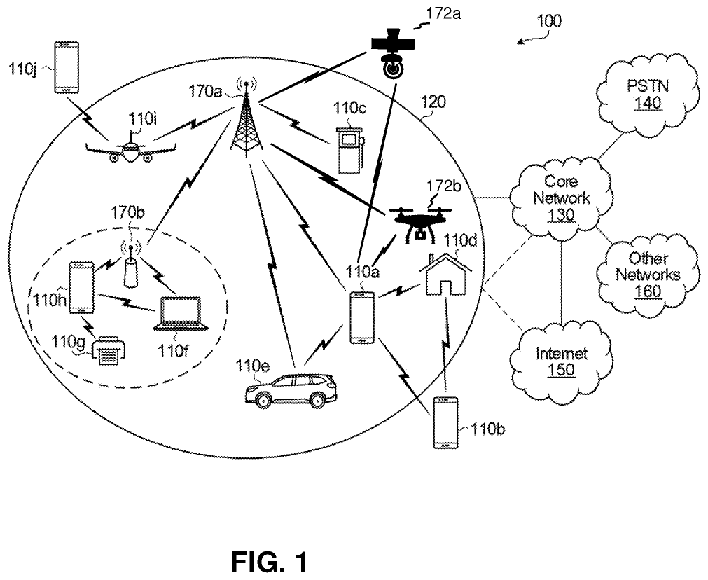

Referring to FIG. 1, as an illustrative example without limitation, a simplified schematic illustration of a communication system is provided. The communication system 100 (which may be a wireless system) comprises a radio access network 120. The radio access network (RAN) 120 may be a next generation (e.g. sixth generation (6G) or later) radio access network, or a legacy (e.g. 5G, 4G, 3G or 2nd generation (2G)) radio access network. One or more communication electronic device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170, or non-terrestrial network nodes 172a or 172b) in the radio access network 120. A core network 130 may be a part of the communication system and may be dependent or independent of the radio access technology used in the communication system 100. The communication system 100 may also comprise a public switched telephone network (PSTN) 140, the internet 150, and other networks 160.

In general, the communication system 100 enables multiple wireless or wired elements to communicate data and other content. The communication system 100 may provide content, such as voice, data, video, and/or text, via broadcast, multicast, groupcast, unicast, etc. And the communication system 100 may provide a wide range of communication services and applications (such as earth monitoring, remote sensing, passive sensing and positioning, navigation and tracking, autonomous delivery and mobility, etc.) The services and/or applications may be mobile broadband (MBB) services, ultra-reliable low-latency communication (URLLC) services, or machine type communication (MTC) services, among other options.

The communication system 100 may operate by sharing resources, such as carrier spectrum bandwidth, between its constituent elements in some cases.

The communication system 100 may, in accordance with some implementations of the present disclosure, include a terrestrial communication system and/or a non-terrestrial communication system. For example, a non-terrestrial base station 172a or an aerial based station 172b may be collectively referred to as a non-terrestrial transmit and receive point (NT-TRP) 172. The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system.

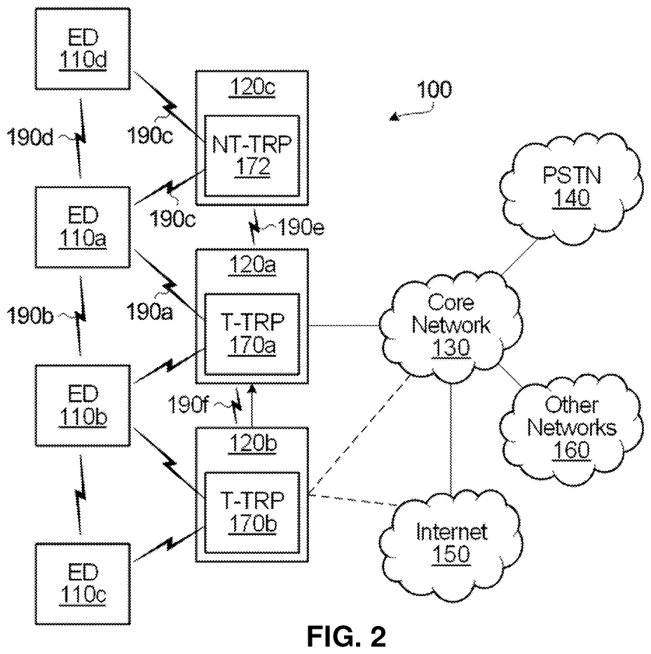

Similar to the example shown in FIG. 1, in the example shown in FIG. 2, the communication system 100 may include ED 110a, 110b, 110c, 110d (generically referred to as ED 110), and RAN 120a, 120b. In addition, the communication system 100 may also include a non-terrestrial communication network 120c. The communication system 100 may also include one or more of a core network 130, a public switched telephone network (PSTN) 140, the Internet 150, and other networks 160. The RANs 120a, 120b include respective RAN nodes such as base stations (BSs) 170a, 170b, which may be generically referred to as terrestrial transmit and receive points (T-TRPs) 170a, 170b. In one implementation, the non-terrestrial communication network 120c includes a RAN node such as an access node (or base station) 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANs 120a, 120b. In another implementations, the non-terrestrial communication network 120c may include at least one non-terrestrial network (NTN) device and at least one corresponding terrestrial network device, wherein the at least one non-terrestrial network device works as a transport layer device and the at least one corresponding terrestrial network device works as a RAN node, which communicates with the ED via the non-terrestrial network device. In addition, there may be an NTN gateway in the ground (i.e., referred to as a terrestrial network device) also as a transport layer device to communication with both the NTN device, and the RAN node communicates with the ED via the NTN device and the NTN gateway. In some implementations, the NTN gateway and the RAN node may be located in the same device.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

The EDs 110a-110d and base stations 170a-170b, 172 are examples of communication equipment that can be configured to implement some or all of the operations and/or implementations described herein. In the example shown in FIG. 2, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some implementations, there may be established pico or femto cells where the radio access technology supports such. In some implementations, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 may communicate with one another over one or more air interfaces 190e, 190f using wireless communication links e.g., radio frequency (RF), microwave, infrared (IR), etc. The air interfaces 190e, 190f may utilize any suitable radio access technology, and may be substantially similar to the air interfaces 190a, 190c over which the EDs 110a-110d communicate with one or more of the base stations 170a-170b, 172 or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190e, 190f.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink (UL) and/or downlink (DL) transmission over a terrestrial air interface 190a with T-TRP 170a. In some examples, the EDs 110a, 110b, 110c, and 110d may also communicate directly with one another via one or more sidelink (SL) air interfaces 190b. In some examples, ED 110d may communicate an uplink and/or downlink transmission over a non-terrestrial air interface 190c with NT-TRP 172.

An air interface (e.g., 190a, 190b, 190c) generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link (e.g., a “Uu” link) between a radio access network (e.g., RAN 120) and user equipment (e.g., ED 110) and/or the wireless communications link may support a link (e.g., a sidelink) between device (e.g., ED 110a) and device (e.g., ED 110b), such as between two user equipments, and/or the wireless communications link may support a link between a non-terrestrial (NT)-communication network (e.g., RAN 120c) and user equipment (e.g., ED 110d). The following are some examples for the above components.

A waveform component may specify a shape and form of a signal being transmitted. Waveform options may include orthogonal multiple access waveforms and non-orthogonal multiple access waveforms. Non-limiting examples of such waveform options include orthogonal frequency division multiplexing (OFDM), discrete Fourier transform spread OFDM (DFT-OFDM), filtered OFDM (f-OFDM), time windowing OFDM, filter bank multicarrier (FBMC), universal filtered multicarrier (UFMC), generalized frequency division multiplexing (GFDM), wavelet packet modulation (WPM), faster than Nyquist (FTN) waveform and low peak to average power ratio waveform (low PAPR WF), among others.

A frame structure component may specify a configuration of a frame or group of frames. The frame structure component may indicate one or more of a time, frequency, pilot signature, code, subcarrier spacing, cyclic prefix length or other parameter of the frame or group of frames, among others. More details of frame structure will be discussed hereinafter.

A multiple access scheme component may specify multiple access technique options, including technologies defining how communicating devices share a common physical channel, such as: code division multiple access (CDMA), space division multiple access (SDMA), time division multiple access (TDMA), frequency division multiple access (FDMA), orthogonal FDMA (OFDMA), single-carrier FDMA (SC-FDMA) which is also known as discrete Fourier transform spread OFDMA(DFT-s-OFDMA), low density signature multicarrier CDMA (LDS-MC-CDMA); non-orthogonal multiple access (NOMA); pattern division multiple access (PDMA); lattice partition multiple access (LPMA); resource spread multiple access (RSMA); and sparse code multiple access (SCMA), among others. Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access, among others. The air interfaces 190a and 190b may utilize other higher dimension signal spaces, which may involve a combination of orthogonal and/or non-orthogonal dimensions.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low peak-to-average power ratio (PAPR) modulation, among others.

The air interfaces 190a and 190b may use similar communication technology, such as any suitable radio access technology.

The non-terrestrial air interface 190c can enable communication between the ED 110d and one or multiple NT-TRPs 172 via a wireless link or simply a link. For some non-limiting examples, the link may be a dedicated connection for unicast transmission, a connection for broadcast transmission, or a connection between a group of EDs 110 and one or multiple NT-TRPs 172 for multicast transmission.

The RANs 120a and 120b are in communication with the core network 130 in the example of FIG. 2 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP), user datagram protocol (UDP). EDs 110a 110b, and 110c may be multimode devices capable of operation according to multiple radio access technologies, and incorporate multiple transceivers necessary to support such.

In addition, the communication system 100 may comprise a sensing agent (not shown in the figure) to manage the sensed data from ED 110 and or the T-TRP 170 and/or NT-TRP 172. In one implementation, the sensing agent is located in the T-TRP 170 and/or NT-TRP 172. In another implementation, the sensing agent is a separate node which has interface to communicate with the core network 130 and/or the RAN 120 (e.g., the T-TRP 170 and/or NT-TRP 172).

However, the example of FIG. 2 above is merely provided for illustration purposes, and other examples of networks and network elements would be apparent to those skilled in the art.

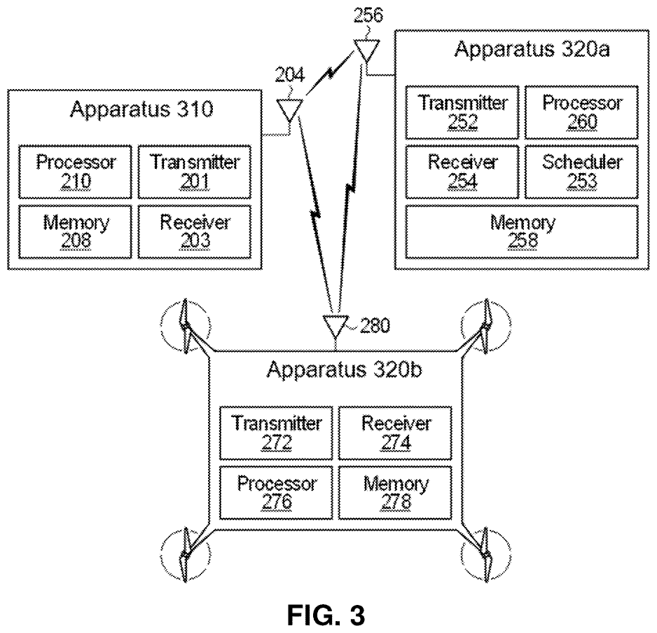

FIG. 3 illustrates an example of an Apparatus 310 wirelessly communicating with at least one of two apparatuses (e.g., Apparatus 320a and Apparatus 320b, referred as Apparatus 320) in a communication system, e.g., the communication system 100, according to one embodiment. The Apparatus 310 may be a UE (e.g., ED 110 in FIG. 3). The Apparatus 320a may be a terrestrial network device (e.g., T-TRP 170 as shown in FIG. 3), and Apparatus 320b may be a non-terrestrial network device (e.g., NT-TRP 172 as shown in FIG. 3). However, this is not necessary. For example, Apparatus 320a may be a NT-TRP, and 320b may be a T-TRP, both Apparatus 320a and 320b may be T-TRPs or NT-TRPs, according to present disclosure. In the following, the ED 110 as an example of the Apparatus 310 is described, and T-TRP 170 as an example of Apparatus 320a is described, and NT-TRP 172 as an example of Apparatus 320b is described. Although only one Apparatus 310, one Apparatus 320a and one Apparatus 320b are illustrated, please note that the number of Apparatus 310 (e.g. ED 110) could be one or more, and the number of Apparatus 320a and/or 320b could vary. For example, one ED 110 may be served by only one T-TRP 170 (or one NT-TRP 172), by more than one T-TRP 170, by more than one NT-TRP 172, or by one or more T-TRP 170 and one or more Nt-TRP172.

The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to but not limited to) as a user equipment/device (UE), a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the foregoing devices, among other possibilities. Future generation EDs 110 may be referred to using other terms. The base stations 170a and 170b are T-TRPs and will hereafter be referred to as T-TRP 170. Also shown in FIG. 3, a non-terrestrial (NT) device will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one or more of: connection availability and connection necessity.

As shown in FIG. 3, the ED 110 includes at least one processor 210. Only one processor 210 is illustrated to avoid congestion in the drawing. The ED 110 may further include a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The ED 110 may include at least one memory 208. Only the transmitter 201, receiver 203, processor 210, memory 208, and antenna 204 are illustrated for simplicity, but the ED 110 may include one or more other components.

The memory 208 may store instructions. The memory 208 may also store data used, generated, or collected by the ED 110. For example, the memory 208 could store software instructions or modules configured to implement some or all of the functionality and/or implementations described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The processor 210 performs (or controlling the ED 110 to perform) operations described herein as being performed by the ED 110. As illustrated below and elsewhere in the present disclosure. For example, the processor 210 may perform or may control the ED 110 to perform receiving transport blocks (TBs), using a resource for decoding of one of the received TBs, releasing the resource for decoding of another of the received TBs, and/or receiving configuration information configuring a resource. In details, the operation may include those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission, among other options. Processing operations related to processing downlink transmissions may include operations such as receive beamforming, demodulating and decoding received symbols, among other options. Processing operations related to processing sidelink transmissions may include operations such as transmit/receive beamforming, modulating/demodulating and encoding/decoding symbols, among other options. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some implementations, the processor 210 may implement the transmit beamforming and/or the receive beamforming based on the indication of beam direction, e.g. beam angle information (BAI), received from the T-TRP 170. In some implementations, the processor 210 may perform operations relating to network access (e.g. initial access) and/or downlink synchronization, such as operations relating to detecting a synchronization sequence, decoding and obtaining the system information, etc. In some implementations, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

In some implementations, the ED 110 may be an apparatus (also called component) for example, a communication module, modem, chip, or chipset, it includes at least one processor 210, and an interface or at least one pin. In this scenario, the transmitter 201 and receiver 203 may be replaced by the interface or at least one pin, where the interface or at least one pin connects the apparatus (e.g., chip) and other apparatus (e.g., chip, memory, or bus). Accordingly, the transmitting information to the NT-TRP 172 and/or the T-TRP 170 and/or another ED 110 may be referred to as transmitting information to the interface or at least one pin, or as transmitting information to the NT-TRP 172 and/or the T-TRP 170 and/or another ED 110 via the interface or at least one pin. The receiving information from the NT-TRP 172 and/or the T-TRP 170 and/or another ED 110 may be referred to as receiving information from the interface or at least one pin, or as receiving information from the NT-TRP 172 and/or the T-TRP 170 and/or another ED 110 via the interface or at least one pin. The information may include control signaling and/or data. For other nodes/entities in this disclosure, similar rules may apply.

As shown in FIG. 3, the T-TRP 170 may include at least one processor 260. Only one processor 260 is illustrated to avoid congestion in the drawing. The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro base station (BS), a pico BS, a relay node, a donor node, or the like, or combinations thereof. The T-TRP 170 may refer to the foregoing devices or refer to apparatus (e.g. a communication module, a modem, or a chip) in the foregoing devices.

In some implementations, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some implementations, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some implementations, the T-TRP 170 may actually be a plurality of T-TRPs that are operating together to serve the ED 110, e.g. through the use of coordinated multipoint transmissions.

The processor 260 performs operations including those related to: preparing a transmission for downlink transmission to the ED 110, processing an uplink transmission received from the ED 110, preparing a transmission for backhaul transmission to the T-TRP 170 and/or NT-TRP 172, and processing a transmission received over backhaul from the T-TRP 170 and/or NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some implementations, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some implementations, the processor 260 may generate signaling, e.g. to configure one or more parameters of the ED 110 and/or one or more parameters of the NT-TRP 172. Any signaling generated by the processor 260 may be sent by the transmitter 252.

The scheduler 253 may be coupled to the processor 260 or integrated in the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources.

The memory 258 may be configured to store information, and optionally data. The memory 258 may store instructions and data used, generated, or collected by the T-TRP 170. For example, the memory 258 could store software instructions or modules configured to implement some or all of the functionality and/or implementations described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

When the T-TRP 170 is an apparatus (also called as component), for example, a communication module, modem, chip, or chipset in a device, it includes at least one processor, and an interface or at least one pin. In this scenario, the transmitter 252 and receiver 254 may be replaced by the interface or at least one pin, where the interface or at least one pin connects the apparatus (e.g., chip) and other apparatus (e.g., chip, memory, or bus). Accordingly, the transmitting information to the NT-TRP 172 and/or the T-TRP 170 and/or ED 110 may be referred to as transmitting information to the interface or at least one pin. The receiving information from the NT-TRP 172 and/or the T-TRP 170 and/or ED 110 may be referred to as receiving information from the interface or at least one pin. The information may include control signaling and/or data.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station.

As shown in FIG. 3, The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

As shown in FIG. 3, the NT-TRP 172 may include at least one processor 276. Only one processor 276 is illustrated to avoid congestion in the drawing. The NT-TRP 172 may include a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 may further include at least one memory 278. The NT-TRP 172 may further include scheduler. Only the transmitter 272, receiver 274, processor 276, memory 278, antenna 280 are illustrated for simplicity, but the NT-TRP may include one or more other components.

The NT-TRP 172 includes a processor 276 for performing operations, and may include those related to: preparing a transmission for downlink transmission to the ED 110, processing an uplink transmission received from the ED 110, preparing a transmission for backhaul transmission to T-TRP 170 and/or another NT-TRP 172, and processing a transmission received over backhaul from the T-TRP 170 and/or another NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some implementations, the processor 276 implements the transmit beamforming and/or receive beamforming based on beam direction information (e.g. BAI) received from the T-TRP 170. In some implementations, the processor 276 may generate signaling, e.g. to configure one or more parameters of the ED 110. In some implementations, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The memory 278 may be configured to store information and optionally data. The memory 278 may store instructions and data used, generated, or collected by the NT-TRP 172. For example, the memory 278 could store software instructions or modules configured to implement some or all of the functionality and/or implementations described herein and that are executed by the processor 276.

Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some implementations, the NT-TRP 172 may actually be a plurality of NT-TRPs that are operating together to serve the ED 110, e.g. through coordinated multipoint transmissions.

When the NT-TRP 172 is an apparatus (e.g. a communication module, modem, chip, or chipset) in a device, it includes at least one processor, and an interface or at least one pin. In this scenario, the transmitter 272 and receiver 274 may be replaced by the interface or at least one pin, where the interface or at least one pin connects the apparatus (e.g., chip) and other apparatus (e.g., chip, memory, or bus). Accordingly, the transmitting information to the T-TRP 170 and/or another NT-TRP 172 and/or ED 110 may be referred to as transmitting information to the interface or at least one pin. The receiving information from the T-TRP 170 and/or another NT-TRP 172 and/or ED 110 may be referred to as receiving information from the interface or at least one pin. The information may include control signaling and/or data.

Note that “TRP”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”).

The T-TRP 170, the NT-TRP 172, and/or the ED 110 may include other components, but these have been omitted for the sake of clarity.

Note that “signaling”, as used herein, may alternatively be called control signaling, control message, control information, or message for simplicity. Signaling between a BS (e.g., the network node 170) and a terminal or sensing device (e.g., ED 110), or signaling between a different terminal or sensing device (e.g., between ED 110i and ED 110j) may be carried in physical layer signaling (also called as dynamic signaling), which is transmitted in a physical layer control channel. For downlink the physical layer signaling may be known as downlink control information (DCI) which is transmitted in a physical downlink control channel (PDCCH). For uplink, the physical layer signaling may be known as uplink control information (UCI) which is transmitted in a physical uplink control channel (PUCCH). For sidelink, signaling between different terminal or sensing devices (e.g., between ED 110i and ED 110j) may be known as sidelink control information (SCI) which is transmitted in a physical sidelink control channel (PSCCH). Signaling may be carried in a higher-layer (e.g., higher than physical layer) signaling, which is transmitted in a physical layer data channel, e.g. in a physical downlink shared channel (PDSCH) for downlink signaling, in a physical uplink shared channel (PUSCH) for uplink signaling, and in a physical sidelink shared channel (PSSCH) for sidelink signaling. Higher-layer signaling may also be called static signaling, or semi-static signaling. Higher-layer signaling may be radio resource control (RRC) protocol signaling or media access control-control element (MAC-CE) signaling. Signaling may be included in a combination of physical layer signaling and higher layer signaling.

It should be noted that in present disclosure, “information”, when different from “message”, may be carried in one single message, or be carried in more than one separate message.

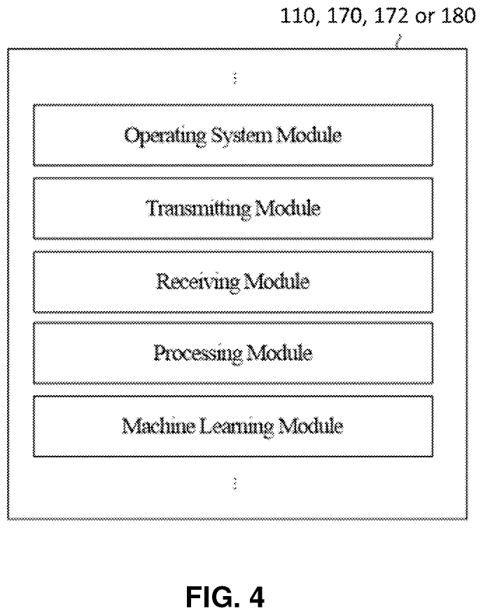

One or more steps of the methods provided in this disclosure may be performed by corresponding units or modules, according to FIG. 4. FIG. 4 illustrates example units or modules in a device or apparatus, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. For other nodes/entities in this disclosure, similar units or modules apply.

Additional details regarding the EDs 110, the T-TRP 170, and the NT-TRP 172 would be known to those of skill in the art. As such, these details are omitted here.

The present disclosure encompasses the following features, from which additional or alternative definitions may also be provided herein:

6th Generation radio access refers to the next generation air interface of cellular standards which may comprise both Terrestrial Networks and Non-Terrestrial Networks.

Coexistence refers to a scenario in which wireless communications networks or links are deployed in adjacent or overlapped frequency bands/channels in overlapped coverage areas.

User Equipment refers to any device in a wireless communications network which can connect to TN and/or NTN.

Base station (eNB/gNB, for example) refers to access nodes in 2G, 3G, 4G, 5G or 6G networks which provide connectivity between the UE and the core network. Access nodes such as base station nodes are responsible for allocating/configuring resources and transmission/reception in a set of cells.

Cell is a Radio network object that can be uniquely identified by a UE from a (cell) identification that is broadcasted over a geographical area from TRPs or access nodes associated with the cell. A Cell can be either FDD or TDD mode. A cell may also refer to the carrier frequencies within the DL/UL carrier bandwidth resources of a single standalone carrier or a component carrier in a carrier aggregation mode.

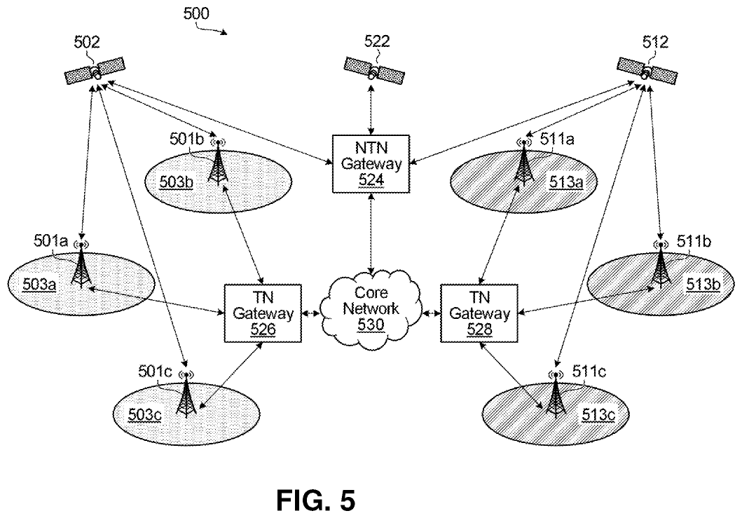

FIG. 5 illustrates an example network 500 in which network devices and serving cells may communicate and operate in accordance with implementations of the present disclosure. The network 500 may be an integrated terrestrial and non-terrestrial network system. The network 500 includes network devices 501a, 501b, 501c, 511a, 511b, and 511c. The network 500 may also include a first serving cell, represented by the non-terrestrial network device 502, a second serving cell, represented by the non-terrestrial network device 512, and/or a third serving cell, represented by the non-terrestrial network device 522. The network 500 may further include at least one non-terrestrial network (NTN) gateway 524, a first terrestrial network (TN) gateway 526, a second terrestrial network (TN) gateway 528, and/or a core network 530.

In some implementations, there may be more than one NTN gateway 524 and different NTN devices may connect to different NTN gateways. For example, there are two NTN gateways 524a and 524b (which is not shown in FIG. 5), both NTN gateway 524a and 524b connect to the core network 530, wherein NTN device 502 connects to NTN gateway 524a, NTN device 522 connects to NTN gateway 524a and NTN gateway 524b, and NTN device 512 connects to NTN gateway 524b.

In some implementations, each of the network devices 501a, 501b, 501c, 511a, 511b, and 511c may be a terrestrial TRP. The network device 501a may serve a coverage area 503a on which one or more terminal devices (not shown in FIG. 5) may camp. Similarly, other network devices 501b, 501c, 511a, 511b, and 511c may serve coverage areas 503b, 503c, 513a, 513b, and 513c, respectively, on which one or more terminal devices (not shown in FIG. 5) may camp, as illustrated in FIG. 5. The network devices 501a, 501b, and 501c may be communicatively connected to the core network 530 via the first TN gateway 526. Additionally or alternatively, the network devices 501a, 501b, and 501c may be communicatively connected to the core network 530 via the first serving cell represented by the non-terrestrial network device 502 and the NTN gateway 524. The network devices 511a, 511b, and 511c may be communicatively connected to the core network 530 via the second TN gateway 528. Additionally or alternatively, the network devices 511a, 511b, and 511c may be communicatively connected to the core network 530 via the second serving cell represented by the non-terrestrial network device 512 and the NTN gateway 524.

In some implementations, the network devices 501a, 501b, and 501c may be communicatively connected to the first serving cell via the non-terrestrial network device 502, and the network devices 511a, 511b, and 511c may be communicatively connected to the second serving cell via the non-terrestrial network device 512. In some other implementations, one or more of the network devices 501a, 501b, 501c, 511a, 511b, and 511c have no direct connection with the NTN device 502, 512 and 522. Instead, they communicate with each other via a TN gateway and a NTN gateway.

Each of the first serving cell, the second serving cell, and the third serving cell may be part of a satellite constellation. The satellite constellation typically includes a plurality of satellite orbits, and each satellite orbit may include a plurality of satellites (e.g., non-terrestrial network devices 502, 512, and 522) therein. Some or all of the satellites in the satellite constellation (e.g., first and second serving cells 502 and 512) may provide wireless coverage or network services to Earth (e.g., network devices 501a, 501b, 501c, 511a, 511b, and 511c).

The satellite constellation may be communicatively connected to the core network 530 through dedicated satellite gateways. For example, the first, second, and third serving cells may be communicatively connected to the core network 530 via the non-terrestrial network device 502, via the non-terrestrial network device 512 and via the non-terrestrial network device 522, respectively, and through the NTN gateway 524 that is dedicated to the first, second, and third serving cells, as described in FIG. 5.

However, the example of FIG. 5 and the specific elements described in FIG. 5 are provided for illustration purposes, and those skilled in the art will appreciate that the configuration of a network and elements present in the network may, in practice, differ from the embodiment described in FIG. 5.

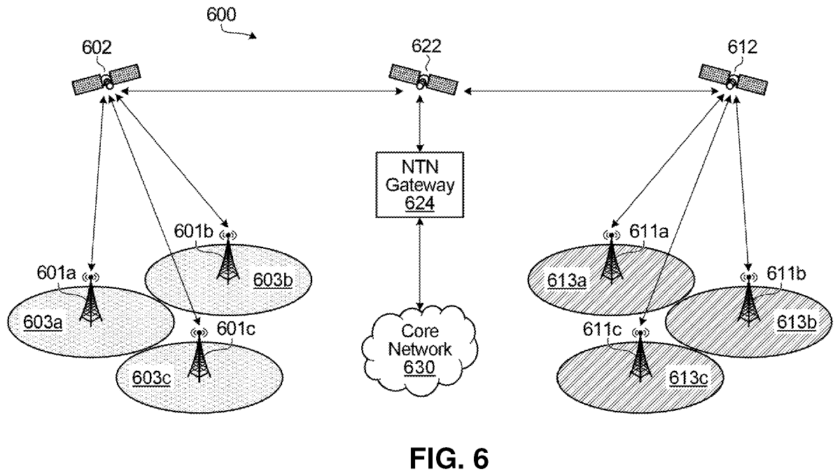

FIG. 6 illustrates another example network 600 in which network devices and serving cells may communicate and operate in accordance with implementations of the present disclosure. The network 600 may be an integrated terrestrial and non-terrestrial network system. The network 600 may be considered a variant of the network 500 described above and in FIG. 5. The network 600 includes network devices 601a, 601b, 601c, 611a, 611b, and 611c. The network 600 may also include a first serving cell represented by the non-terrestrial network device 602, a second serving cell represented by the non-terrestrial network device 612, and/or a third serving cell represented by the non-terrestrial network device 622. The network 600 may further include at least one NTN gateway 624 and a core network 630.

In some implementations, there may be more than one NTN gateway 624 and different NTN devices may connect to different NTN gateways. For example, there are two NTN gateways 624a and 624b (which is not shown in FIG. 6), both NTN gateway 624a and 624b connect to the core network 630, wherein NTN device 602 connects to NTN gateway 624a, NTN device 622 connects to NTN gateway 624a and NTN gateway 624b, and NTN device 612 connects to NTN gateway 624b.

In some implementations, each of the network devices 601a, 601b, 601c, 611a, 611b, and 611c may be a terrestrial TRP. The network device 601a may serve a coverage area 603a on which one or more terminal devices (not shown in FIG. 6) may camp. Similarly, other network devices 601b, 601c, 611a, 611b, and 611c may serve coverage areas 603b, 603c, 613a, 613b, and 613c, respectively, on which one or more terminal devices (not shown in FIG. 6) may camp. The network devices 601a, 601b, and 601c may be communicatively connected to the first serving cell via the non-terrestrial network device 602, for example using wireless links. The network devices 601a, 601b, and 601c may be communicatively connected to the core network 630 via the first serving cell represented by the non-terrestrial network device 602, the third serving cell represented by the non-terrestrial network device 622, and the NTN gateway 624, as illustrated in FIG. 6. The network devices 611a, 611b, and 611c may be communicatively connected to the second serving cell via the non-terrestrial network device 612, for example using wireless links. The network devices 611a, 611b, and 611c may be communicatively connected to the core network 630 via the second serving cell represented by the non-terrestrial network device 612, the third serving cell represented by the non-terrestrial network device 622, and the NTN gateway 624, as illustrated in FIG. 6.

The first serving cell, the second serving cell, and the third serving cell may be communicatively connected to each other via the non-terrestrial network device 602, via the non-terrestrial network device 612 and via the non-terrestrial network device 622, respectively, as illustrated in FIG. 6, for example via free space optical links (e.g., lasers).

In some implementations, each of the first serving cell, the second serving cell, and the third serving cell may be part of a satellite constellation. The satellite constellation typically includes a plurality of satellite orbits, and each satellite orbit may include a plurality of satellites (e.g., non-terrestrial network devices 602, 612, and 622) therein. Some (or all) of the satellites in the satellite constellation (e.g., non-terrestrial network devices 602 and 612) may provide wireless coverage or network services to earth (e.g., network devices 601a, 601b, 601c, 611a, 611b, and 611c). The satellites in the satellite constellation (e.g., non-terrestrial network devices 602, 612, 622) may effectively act as a gateway for network devices on the ground (e.g., network devices 601a, 601b, 601c, 611a, 611b, and 611c). The satellites in the satellite constellation may be communicatively connected to the core network 630 through an NTN gateway located on the ground using wireless links. For example, the non-terrestrial network devices 602, 612, 622 may be communicatively connected to the core network 630 through the NTN gateway 624, as illustrated in FIG. 6.

In some implementations, the NTN gateway 624 may be communicatively connected to the core network 630 using wireless links, wired links (e.g., fiber optical links), or combination thereof.

For illustrative purposes, specific example implementations will now be explained in greater detail in conjunction with the figures and above mentioned system, ED and TRP.

However, the example of FIG. 6 and the specific elements described in FIG. 6 are provided for illustration purposes, and those skilled in the art will appreciate that the configuration of a network and elements present in the network may, in practice, differ from the embodiment described in FIG. 6.

The implementations set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

The present disclosure is directed to the use of terrestrial network elements in message exchanges between User Equipments (UEs) and NT BSs for improved utilization of system resources and to achieve reliable and increased transmission capacity.

Using beam hopping technology in Low Earth Orbit (LEO) NTN communication system can effectively address uneven and dynamic requirement issues in NT communications and can enhance the utilization of NT BS resources in the network.

In particular, the Beam Hopping Planning Table (BHPT) is a table that defines the sequence and timing of beam activation. Using the beam hopping planning table, the NT system can dynamically adjust its beams to cater to user demands and adjust beams based on their efficiency as communicated through feedback.

Beam hopping can be further enhanced with multiple beams activated concurrently. Instead of hopping from one beam to another sequentially, a pattern of multiple beams can be hopped through, allowing for more sophisticated traffic management strategies.

Activating multiple beams poses challenges in terms of potential interference, especially if beams are adjacent or if frequencies overlap. Because each beam can share the full frequency band and total power of the NT BS, the co-frequency interference of adjacent beams or within other networks (terrestrial or aerial networks operating on the same frequency and under the same beam) gets worse in the system with BH technology. Therefore, inter-beam interference becomes a significant limiting factor for system performance.

Moreover, the resource allocation algorithm of a NT BS BH system mainly focuses on the aspects of bandwidth, power and time slot allocation. Reducing the common channel interference of the system and other conditions are taken as constraints. The realization of maximum resource utilization may be the optimization goal of the model created for such NT BS BH system.

While optimization models have been created in the past, they have failed to tackle the issue of interference and optimization from a signaling perspective. In accordance with implementations of the present disclosure, terrestrial network elements such as a Terrestrial Next Generation Node B (T-gNB), are used to reduce the interference and improve resource allocation in BH models.

Specifically, conventional beam hopping involves exchanging signaling messages between terrestrial network (TN) or NTN terminal devices and a NT BS, or monitoring the received signal quality, to confirm the effectiveness of the beam hopping and adjust it based on TN or NTN terminal device feedback. However, integrating terrestrial network elements in this process and using their interference measurements instead of feedback directly from terminal devices can assist beam hopping from the NT BS perspective compared to relying solely on terminal device feedback.

In particular, feedback directly from terminal devices in such system may not be the most efficient use of resources for several reasons. These may include distance and propagation delay and limited uplink capacity. In the case of relying solely on terminal device feedback, the NT BS's beam hopping controller would primarily rely on the measurements and reports received from individual terminal devices. Each terminal device may provide feedback based on its own localized experience, such as signal strength, signal quality, and perceived interference levels. However, this feedback may not capture the complete interference picture across the entire coverage area. TN or NTN terminal device feedback has limitations due to the subjective nature of individual measurements and the potential variations caused by factors like user mobility and signal fluctuations. Such individual feedback may not provide a comprehensive understanding of the interference environment, particularly in scenarios where multiple terminal devices may have different perceptions of interference depending on their locations.

Thus, even if all terminal devices are capable of directly sending their interference measurements to NT BSs, there would still be several advantages in having aggregated feedback from terrestrial network elements.

In a first aspect, signaling overhead could be reduced by relying on feedback from terrestrial network elements. If every terminal device directly sends its interference measurements to the NT BS, this could result in significant signaling overhead, especially in dense deployment scenarios with numerous terminal devices. Aggregated feedback from terrestrial network elements can reduce the number of individual messages that the NT BS has to process.

In a second aspect, network visibility can be enhanced. Terrestrial network elements are designed to manage multiple terrestrial devices in their coverage area. They have a better understanding of the local radio environment, including knowledge about neighboring cells and terminal devices, allowing them to provide more accurate interference information than a terminal device.

In a third aspect, spatial interference may be correlated. Terrestrial network elements can analyze and provide spatial correlation information about interference sources. Such information is hard to infer from individual terminal device feedback as terminal devices do not share their interference measurements with each other.

In a fourth aspect, resources may be more efficiently utilized. Sending feedback to the NT BS requires resources. Given the limited uplink capacity of terminal devices and the power consumption associated with transmissions, it may be more efficient to have terrestrial network elements send aggregated feedback.

In a fifth aspect, the timeliness and relevance of feedback can be improved. Due to the large distances involved in NTN communications, there could be significant propagation delays for feedback signals from terminal devices. Terrestrial network elements, which maintain continuous communication with terminal devices, can provide more timely and relevant feedback.

In a sixth aspect, advanced analysis capabilities may be improved. Terrestrial network elements have more computational resources than individual terminal devices, allowing them to apply advanced data analysis methods to interference measurements. They can interpret raw data and send only the essential information to the NT BS, reducing overhead and improving the quality of feedback.

Further, terrestrial network elements continuously monitor the interference conditions in their respective coverage areas. They collect interference measurements, such as signal-to-interference-plus-noise ratio (SINR), interference power levels, and interference sources detected in the network. Sharing this information with the NT BS's beam hopping controller can provide a comprehensive view of the interference environment across the urban area.

Some or all of these advantages, along with other advantages, may be realized with the implementations of the present disclosure. Based on this, methods and systems are provided in which terrestrial network elements are involved with feedback to improve non-terrestrial network performance.

In still further implementations, instead of, or in addition to, interference, scheduling for NTN communications may be performed using terrestrial network elements.

These implementations are described below.

### System

The implementations of the present disclosure focus on beam hopping in NTN communications, where a terminal device such as a User Equipment (UE) can simultaneously connect to both a terrestrial network element such as a gNB and a NT BS.

In some aspects, this system model assumes a high density of terminal devices, and it also provides a NT BS which is equipped with multi-beam antennas, where the NT BSs may adjust the beam hopping pattern based on feedback from terrestrial devices.

Additionally, in some cases multiple terrestrial network elements or aerial network elements may be under the coverage of the same beam of the NT BS.

Moreover, in some cases terrestrial network elements may interact with each other for possible coordination among themselves, where such terrestrial network elements may be equipped with enough processing power for aggregating received interference from terminal devices to assist NT BSs in generating beam hopping pattern in non-terrestrial networks.

Terrestrial network elements may be equipped with antennas having higher gain, height, and transmit power in comparison to terminal devices, and in various implementations of the present disclosure can directly communicate with NT BSs.

In some cases, terrestrial network devices can operate in a same frequency band as NTN terminal devices communicating with NT BSs, while on other occasions their operating frequency can be different.

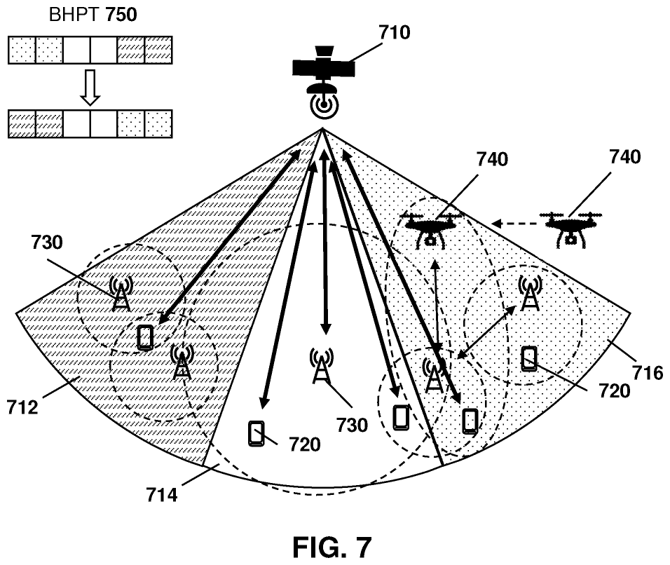

Thus, reference is now made to FIG. 7. In the embodiment of FIG. 7, an NT BS 710 may have a plurality of beams 712, 714 and 716. While the example of FIG. 7 only includes three beams, it will be appreciated by those in the art that a system may have more or fewer beams, and the present disclosure is not limited to the number of beams being emitted by NT BS 710.

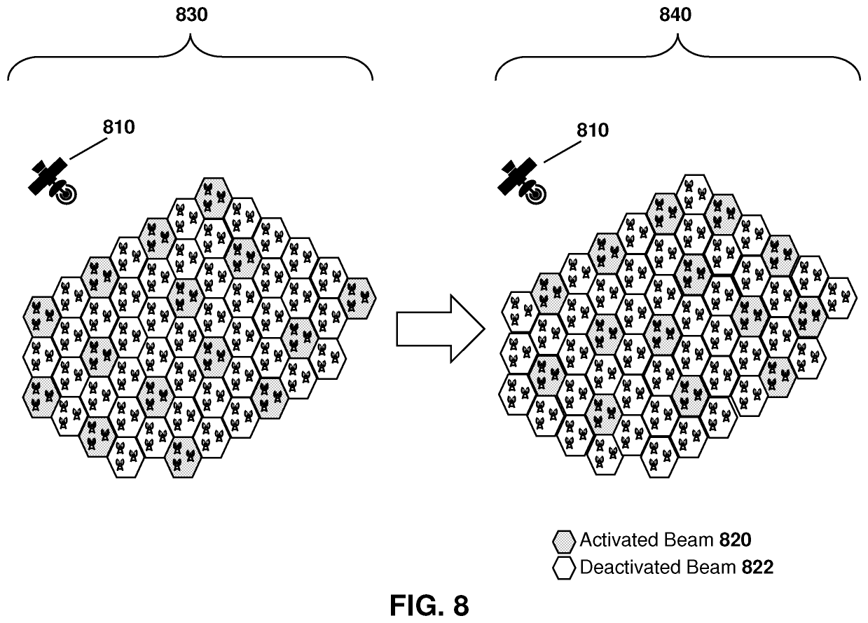

Further, for clarity the example of FIG. 7 has each of the beams 712, 714 and 716 being energized one at a time. However, in practice, and as described below with regard to FIG. 8, multiple beams could be energized concurrently.

A plurality of terminal devices 720 may be non-terrestrial, meaning that they may communicate directly with NT BS 710. In other cases, terminal devices 720 could communicate with terrestrial network elements 730 and/or with aerial network elements 740. In the example of FIG. 7, it is assumed that aerial network elements 740 (e.g. aerial gNBs, drones) are either connected to T-gNBs or the TN core network; therefore, they are considered as a TN node in this scenario.

With beam hopping, the pattern of the beams may be adjusted to ensure system performance is optimized. For example, the embodiment of FIG. 7 provides a scenario in which, when a source of interference is sensed by one network (Terrestrial), it can inform the NTN to adjust the beam hopping based on that. For instance, in FIG. 7, when a drone (network element 740) enters beam 716, a terrestrial network element may promptly inform the satellite regarding the source of interference which had not been visible by NTN network elements (e.g. NTN UEs). Therefore, an NTN examining terrestrial network element feedback, and identifying the source and direction of interference, may then update the beam hopping pattern in a way that when the source of interference is in one beam, that beam may remain inactive, for example. However, other options for varying beam hopping based on performance optimization are possible.

Based on this, the embodiment of FIG. 7 shows how the beam hopping pattern 750 may change.

Referring to FIG. 8, this example shows a plurality of areas may be covered by a NT BS 810. The pattern of the activated beams 820 and deactivated beams 822 may change from a first time 830 to a second time 840. In the example of FIG. 8, multiple beams can be active at the same time.

The pattern of the activated beams 820 and deactivated beams 822 may be adjusted based on various factors, including interference mitigation in some cases.

In the example of FIG. 8, the pattern of which beams are energized at a particular time may be adjusted based on feedback. Further, not all the deactivated beams will activate at the same time, nor will all the activated beams deactivate at the same time. Rather, a beam hopping schedule will determine whether each beam is activated or deactivated at a particular time.

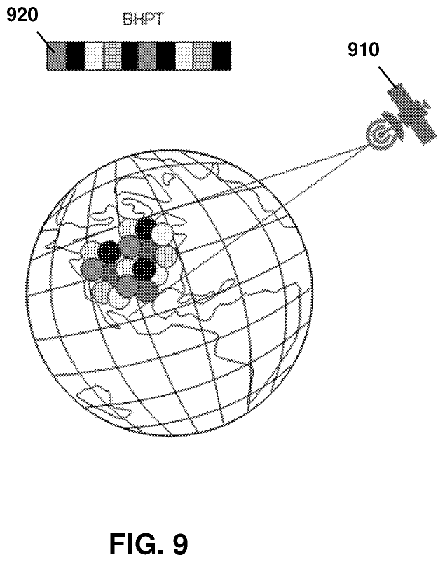

FIG. 9 shows an example NT BS 910 servicing North America, where a beam hopping pattern 920 may be used, for example based on time of day. Thus, for example, network usage may be higher during the evening, and thus beams on the east coast may be more used during a first time frame corresponding to the evening hours on the east coast, whereas beams on the west coast may be used more frequently or for longer periods during a second timeframe. Other options are possible.

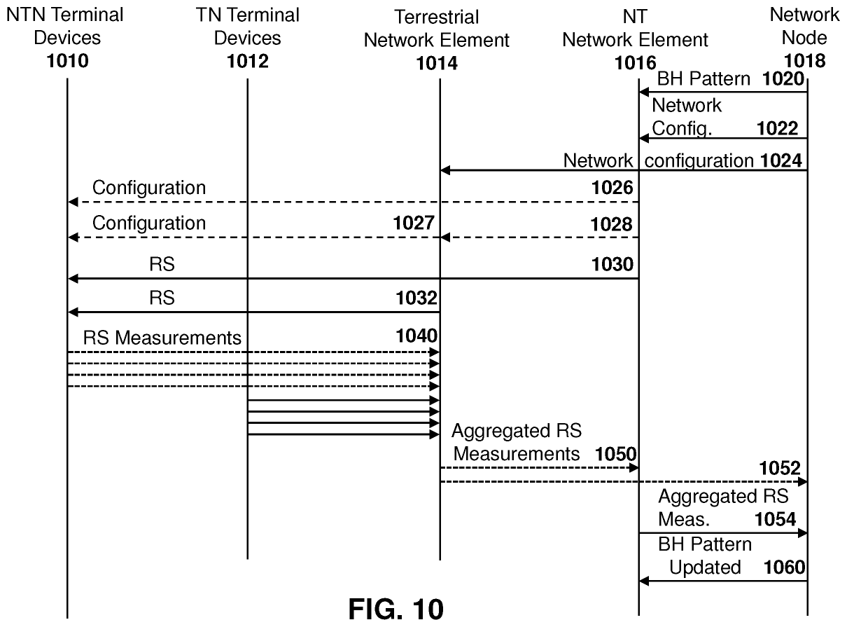

A high level overview of one embodiment of the present disclosure is provided with regard to FIG. 10.

In the embodiment of FIG. 10, a plurality of non-terrestrial network terminal devices 1010 may exist within the system. Further, a plurality of terrestrial network terminal devices 1012 may also exist in the network.

A terrestrial network element 1014 may service the terrestrial network terminal devices 1012, but may also be capable of receiving messages from and communicating with non-terrestrial network terminal devices 1010.

NT network element 1016, which may for example be a non-terrestrial base station, may service a wide area and may be capable of communicating with the terrestrial network element 1014, as well as the NTN terminal devices 1010.

A network node 1018 can refer to any network component, such as terrestrial network elements, NT BSs, or central units/controllers. As such, network node 1018 can be a terrestrial network node, a non-terrestrial network node, or a combination of TN and NTN network nodes. Further, while network nodes 1018 is shown as a single component, functionality for network node 1018 may be distributed between a plurality of servers or computing devices.

In the example of FIG. 10, network node 1018 may provide NT network element 1016 with a beam hopping pattern 1020. The network node 1018 may further provide network configuration information 1022 to NT network element 1016 as well as network configure information 1024 to terrestrial network element 1014. The network configuration information 1022 and 1024 may include all parameters that terrestrial devices need to know, such as where and what to measure (time, frequency, RS type, etc.), as well as measurement type (periodicity if the measurement is periodic, aperiodic, event triggered measurement, etc.). As shown in FIG. 10, the network node may initially configure the BH pattern and may instruct terminal devices to conduct TN/NTN interference measurements based on the BH pattern.

In some cases, NTN Terminal Devices 1010 may receive configuration messages to guide them on where to direct their feedback, whether to a NT Base Station such as a satellite, or to a terrestrial network element. In particular, in some cases NT network element 1016 may send configuration messages 1026 to NTN Terminal Devices 1010.

In some cases, the configuration message may be provided by Terrestrial Network element 1014 to NTN Terminal Devices 1010, as shown with configuration message 1027 in the example of FIG. 10.

In some cases, the sending of configuration message 1027 may be based on a message 1028 from the NT network element 1016 to Terrestrial Network Element 1014. However, in other cases a different network element may prompt Terrestrial Network Element 1014 to send configuration message 1027.

Further, in addition to, or instead of, directing the NTN Terminal Devices 1010 on where to provide feedback, configuration messages 1026 and/or 1027 may include information on how feedback should be provided, such as a frequency for providing feedback, times to provide feedback, parameters or thresholds for providing feedback, among other options.

Further, in some cases configuration messages 1026 and/or 1027 are optional, and the NTN Terminal Devices may be pre-configured with feedback mechanisms, for example. Other options are possible.

NT network element 1016 may send out reference signals 1030 and Terrestrial network element 1014 may send out reference signals 1032. Terminal devices then carry out interference measurements and provide feedback to the network. This is shown with RS measurement signals 1040 being provided from NTN terminal devices 1010 to terrestrial network element 1014 and RS measurement signals 1042 being provided from TN terminal devices 1012 to terrestrial network element 1014.

As described below, terrestrial network element 1014 may aggregate information from signals 1040 and 1042 and provide an aggregated message 1050 to NT network element 1016. In some cases, the aggregated message 1050 may include a subset of the signals received. In some cases, the aggregated message 1050 may include all of the signals received. In some cases, the aggregated message 1050 may include information derived from the messages received, such as the state of the network, an identification of a source of interference based on evaluating multiple interference measurement feedback from network elements located in different parts of a cell, among other options.

In some cases, rather than message 1050, or in addition to message 1050, the terrestrial network element 1014 may provide an aggregated message 1052 directly to network node 1018. Aggregated message 1052 may include a subset of the signals received. In some cases, the aggregated message 1052 may include all of the signals received. In some cases, the aggregated message 1052 may include information derived from the messages received, such as the state of the network, an identification of a source of interference based on evaluating multiple interference measurement feedback from network elements located in different parts of a cell, among other options.

Further, NT network element 1016 may provide information from aggregated message 1050 to network node 1018 as message 1054. This may occur, for example, if message 1052 is not provided to network node 1018 in some cases. However, in other cases message 1054 may be sent even if message 1052 is sent, for example to add redundancy.

Finally, the network node 1018 may adjust the BH pattern, shown with message 1060, based on the feedback, to provide a new BH pattern to terminal devices.

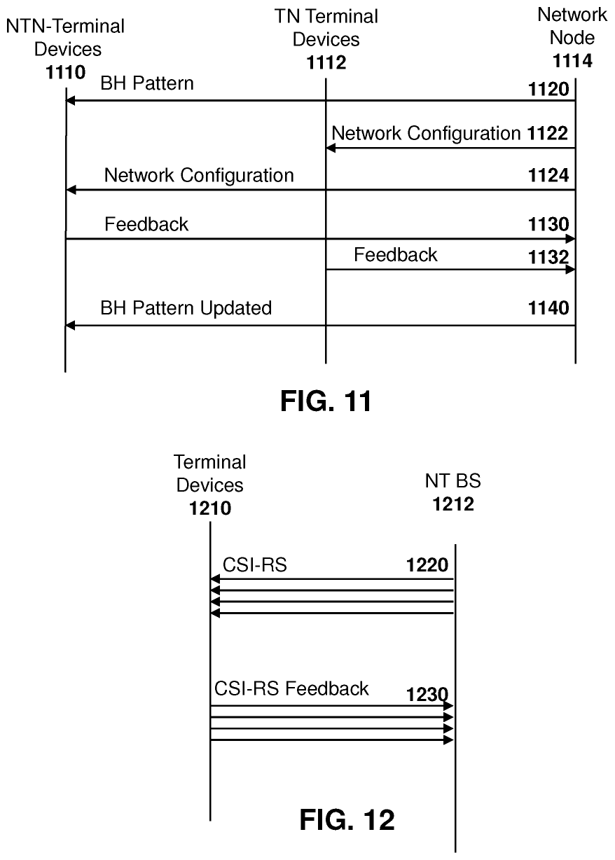

A simplified version of FIG. 10 is shown with FIG. 11, in which NTN terminal devices 1110 and TN terminal devices 1112 both communicate with Network Node 1114. As will be appreciated by those skilled in the art, such communication with Network Node 1114 can be direct or may in some cases be through other network elements. In the example of FIG. 11, the network node 1114 may provide the beam hopping pattern with message 1120 to the NTN terminal devices 1110. Further, the network node 1114 may provide a network configuration message 1122 to the TN terminal devices 1112 and also may provide another configuration message 1124 to the NTN terminal devices 1110. Other messages may further be exchanged.

The network configuration information 1122 and 1124 may include all parameters that terminal devices need to know, such as where and what to measure (time, frequency, RS type, etc.), as well as measurement type (periodicity if the measurement is periodic, aperiodic, event triggered measurement, etc.). Configuration messages 1124 may further provide direction on where feedback should be sent in some cases.

NTN terminal devices 1110 may provide feedback in messages 1130. TN terminal devices may provide feedback in messages 1132.

Finally, the network node 1114 may adjust the BH pattern, shown with message 1140, based on the feedback, to provide a new BH pattern to the terminal devices. Further, while message is shown to be directly between network node 1114 and NTN terminal devices 1110, in some implementations the message may be provided via another network element, such as an NT BS, a terminal network element, among other options.

The embodiment of FIG. 11 is merely provided as an illustration of communications, and other messages, information in messages, and network elements may be provided in practice.

### Interference Aggregation

Utilizing the systems of FIGS. 7 to 11, one embodiment of the present disclosure provides for the delivery of aggregated interference measurements of terminal devices such as UEs to a NT BS.

In the given implementations, multi-beam NT BSs may be present, with the possibility of multiple terrestrial network elements being covered under the same beam by the same NT BS. Additionally, terminal devices may be capable of establishing connections with both the NT BS and their local terrestrial network elements simultaneously.

In particular, reference is now made to FIG. 12, which shows a conventional feedback mechanism. Conventional beam hopping involves exchanging signaling messages between terminal devices and NT BS or monitoring the received signal quality to confirm the effectiveness of the beam hopping and adjust it based on feedback from terminal devices. Thus, in the embodiment of FIG. 12, terminal devices 1210 communicate with an NT BS 1212. The NT BS 1212 may send a plurality of Channel Status Information-Reference Signals (CSI-RS) 1220, which are received by terminal devices 1210.

In response, terminal devices 1210 measure the interference within their respective cells, and based on these measurements, terminal devices 1210 generate interference measurement reports. These reports encompass interference power levels, alongside other pertinent metrics.

Terminal devices 1210 may then transmit this information as CSI feedback in messages 1230 back to NT BS 1212. This feedback may encapsulate various metrics like channel gain, signal-to-noise ratio (SNR), channel quality indicator (CQI), precoding matrix indicator (PMI), and rank indicator (RI), among other options.

At this stage, NT BSs 1212 may adjust their beam hopping pattern based the received feedback.

As will be appreciated by those in the art, significant power is needed to send messages 1230 to the NT BS 1212. Further some messages from terminal devices may contain erroneous information.

Integrating terrestrial network elements such as gNBs in this process and using their interference measurements instead of terminal devices can assist beam hopping from the NT BS's perspective compared to relying solely on terminal device feedback.

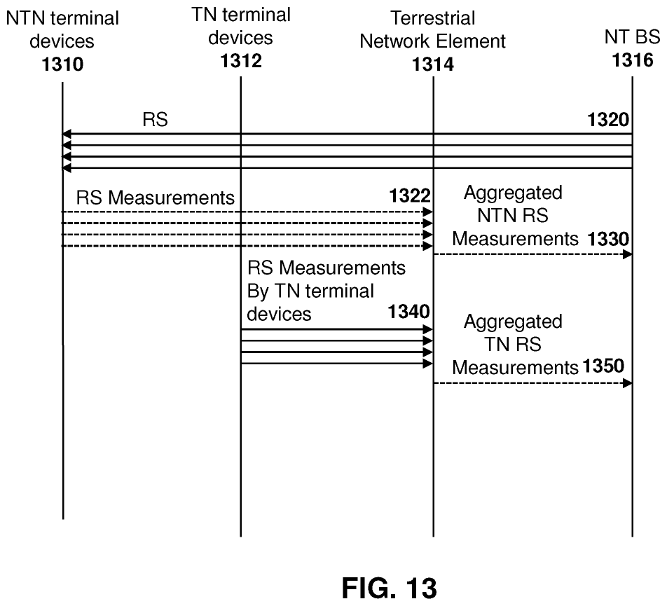

FIGS. 13 to 16 below describe various implementations of providing interference feedback to an NT BS. Each figure shows options for providing feedback. However, in some cases, various implementations of FIGS. 13 to 16 could be combined. In some cases, different implementations from FIGS. 13 to 16 can be used together in a single system, and may be based on specific conditions. Other options are possible.

Further, the implementations of FIGS. 13 to 16 below assume that the NTN Terminal Devices have been configured on where and how to provide feedback, which may be done using messages such as configuration messages 1026, 1027 or 1124 from FIGS. 10 and 11 respectively.

Specifically, reference is now made to FIG. 13. In the embodiment of FIG. 13, instead of solely relying on terminal devices feedback, a more accurate and a lower overhead signaling feedback method is provided by integrating terrestrial network elements during this procedure.

To this end, NTN terminal devices 1310, instead of directly sending their measurement feedback (which can be done based on different reference signals) to NT BSs 1316, may transmit their feedback to local terrestrial network elements 1314 (e.g. a closest network element) and terrestrial network elements 1314 may send NTN terminal devices 1310 and TN terminal devices 1312 aggregated measurements feedback to the corresponding NT BS 1316.

In some implementations, the aggregated feedback can be obtained by evaluating terminal devices feedback over different pilots to identify the amount of received interference at different sources (TN, NTN, co-channel interference, leaked adjacent channel interference, etc.)

Aggregating feedback from both TN and NTN terminal devices can be challenging but vital for optimizing network performance. Interpolation with respect to time and frequencies can help in achieving this aggregation. For instance, NTN terminal devices 1310 experience more significant propagation delays than TN terminal devices 1312. This means that the feedback from NTN terminal devices 1310 refers to an older state of the network than that of TN terminal devices 1312. By interpolating feedback in the time domain, the network can estimate the state of the channel for NTN terminal devices 1310 at the same ‘network time’ as that of the TN terminal devices 1312.

This ensures that decisions made using the aggregated feedback are relevant to the current state of both TN and NTN. Interpolation in the frequency domain becomes about aligning the feedback from the two types of terminal devices to capture the diverse channel conditions they experience on that shared frequency. This may therefore create a cohesive picture of the channel conditions over the shared frequency range.

To this end, for the frequency range where both TN and NTN terminal devices provide feedback, overlapping points or frequency bins may be identified. These are the points where feedback from both types of terminal devices is available and where interpolation will be most effective. If there are gaps or points in the frequency range where feedback from one type of terminal device is missing or unreliable, curve-fitting techniques can be used. This involves using the feedback from the available terminal device type and the interpolated points to predict or estimate the feedback for the missing sections. The interpolated feedback provides a unified view of the channel conditions across the shared frequency range. The network can then use this feedback for various purposes, such as resource allocation, interference management, and adaptive modulation and coding.

While averaging/interpolation of the measurements results can be done at the terminal device side, it is typically done at the network side based on the measurement results feedback from the terminal devices.

Additionally, the accuracy of the received interference measurements can be assessed by calculating the spatial interference correlation. This method takes into account the spatial relationship between various nodes (i.e., terminal devices or terrestrial network elements) in the network and the interfering sources. This can provide a more comprehensive picture of the interference scenario by correlating the interference information across multiple nodes.

Spatial interference correlation exploits the spatial redundancy in interference measurements. Multiple feedback reports from different locations can be combined to create a more reliable and accurate estimate of the interference scenario. This means that if multiple terminal devices or terrestrial network elements provide feedback about the same interference source, each of these reports gives another ‘look’ at the interference scenario. Each report adds to the overall understanding of the interference, even if the individual reports may contain some inaccuracies or noise. By aggregating these reports and looking at the overall trend, a more reliable and accurate estimate of the interference scenario may be created. This may be particularly useful in scenarios with significant random variations in the interference.

One advantage of this redundancy is that it allows for cross-validation and error mitigation. In essence, it enables the building of a composite picture of the interference environment that is potentially more accurate and reliable than any single feedback.

Further, in some cases the feedback reports may be cross-validated against each other for error mitigation. The system can identify potential outliers or erroneous feedback by comparing each report against the majority view. If a particular terrestrial network element's feedback is significantly different from others, the system may deem it as an outlier and discount it during the aggregation process. For instance, if the majority of the terminal devices and terrestrial network elements report high interference from a particular source, it can be inferred that the interference from that source is indeed high, even if a few feedback reports suggest otherwise.

In some cases, after removing the outliers, terrestrial network elements can deliver the average received interference as an aggregated interference measurements to the NT BS. This could be in the form of averaged Signal-to-Interference-plus-Noise Ratio (SINR), aggregated Channel Quality Indicator (CQI) values, or combined reports of specific interference sources. Aggregation can be in form of a mean, median, or any other representative metric. Additionally, weights may be assigned to the feedback from different terminal devices based on criteria like their location, reliability, or other network metrics and aggregate the feedback afterwards.

Further, other results may be derived from the reports, such as a source of interference, and this may be provided as part of the aggregated feedback.

Based on feedback, NTN systems can adjust their beam hopping patterns to avoid interference-prone areas (to prevent conflict with TN) or to strengthen signals in areas with poor reception (to force TN terminal devices with high received interference to switch their networks, for example). Also, if certain frequency bands are consistently reported as interference-prone, the NTN system can consider using alternate bands or adjusting its frequency reuse pattern. Furthermore, if interference is found to be periodic or linked to specific times (from feedback of TN terminal devices), the NTN system can adjust its schedules or resource allocations during those periods. Other adjustments are possible.

Thus, according to the embodiment of FIG. 13, the NT BS 1316 may transmit reference signals 1320, which are received by terminal devices such as NTN terminal devices 1310.

In addition to assessing the quality of the communication channel based on the reference signals 1320, interference measurement may also involve measuring the level of interference in the environment. Interference can come from neighboring cells, co-channel users, or other sources sharing the same frequency spectrum.

Terminal devices can also identify empty resource elements within the spectrum. These measurements help the network understand resource utilization and interference patterns.

NTN terminal devices 1310 may process the signals 1320 and other information, and provide RS Measurement reports 1322, which may be referred to herein as first messages from terminal devices, to terrestrial network element 1314.

Moreover, if a terminal device has location capabilities, it may use GPS or other location techniques to provide its position within in its interference report. This information can be used for identifying the source of interference by the network.

Other information from the environment and/or sensors at the terminal device may also or instead be included in reports 1322.

From reports 1322, an aggregated NTN measurement report 1330 may be provided to NT BS 1316. Aggregated NTN measurement report 1330 could include all the reports 1322 received, a subset of the reports 1322 received, information derived from reports 1322, among other options.

Similarly, TN terminal devices 1312 may provide RS measurement reports 1340 to terrestrial network element 1314. From reports 1340, an aggregated TN measurement report 1350 may be provided to NT BS 1316. Aggregated TN measurement report 1350 could include all the reports 1340 received, a subset of the reports 1340 received, information derived from reports 1340, among other options.

The aggregated NTN measurement report 1330 and aggregated TN measurement report 1350 may have various properties. For example, in some cases the reports 1330 or 1350 may be carried in either the Physical Uplink Control Channel (PUCCH) or the Physical Uplink Shared Channel (PUSCH). Since PUCCH is designed to be used for transmitting control information, in some cases it may be used if the volume of the aggregated feedback is small or periodic. If a significant amount of aggregated feedback exists, or if the feedback is combined with other data, it might be sent on the PUSCH in some cases.

In some cases, the reports 1330 and/or 1350 may include a network element identifier. This may allow the NT BS 1316 to recognize which network element is sending the aggregated feedback. This could assist in identifying the location of the network element, a beam id for the NT transmission, among other information.

In some cases, reports 1330 and/or 1350 may indicate which network feedback is being provided (i.e. TN, NTN).

In some cases, reports 1330 and/or 1350 may indicate a total number of terminal devices that have been aggregated and thus integrated into the data. Knowing the number of terminal devices that contributed to the feedback may provide insights into the weight or reliability of the aggregated data. Feedback aggregated from a larger number of terminal devices might be considered more statistically stable and representative of the overall network condition. Furthermore, understanding the typical number of terminal devices aggregated in the feedback can give network planners insights into the scalability needs of the network.

In some cases, reports 1330 and/or 1350 may indicate an aggregated Channel Quality Indicator (CQI). This may, for example, be an averaged or otherwise processed indication of the overall channel quality from all the aggregated terminal devices. This could be a mean, median, or any other representative metric.

In some cases, reports 1330 and/or 1350 may indicate an aggregated Rank Indicator (RI). For example, this may be a representation of the perceived transmission layers based on the aggregated feedback. Given its discrete nature, determining the mode (most frequently occurring value) of the RI values may be more indicative of the most common Multiple Input, Multiple Output (MIMO) configuration preferred by the aggregated terminal devices. If some terminal devices have higher priority or reliability, their RI values can be given more weight in the aggregation process.

In some cases, reports 1330 and/or 1350 may indicate an aggregated Precoding Matrix Indicator (PMI). This may, for example, include an indication of the overall preferred precoding matrix based on feedback from multiple terminal devices. Similar to RI, if a majority of terminal devices prefer a specific PMI, that PMI can be selected as the aggregated PMI. Also, for each possible PMI, the probability (or frequency) of its selection among the terminal devices can be calculated. The PMI with the highest probability can be selected, or the probabilities themselves can be conveyed to give the transmitter an understanding of the distribution of preferred PMIs.

In some cases, reports 1330 and/or 1350 may indicate an aggregated Reference Signal Received Power (RSRP) and Reference Signal Received Strength Indicator (RSSI). RSRP and RSSI are metrics used to measure signal level and quality. In some scenarios, where not all terminal devices are equal in terms of their importance or their reliability in providing feedback, weights can be assigned to the feedback from different terminal devices based on criteria including their location, reliability, or other network metrics and aggregate the feedback afterwards.

In some cases, reports 1330 and/or 1350 may indicate an interference level, which may comprise a quantified metric representing the overall interference level perceived by the terminal devices. This could be an average Signal-to-Interference-plus-Noise Ratio (SINR) or a similar metric in some implementations.

In some cases, reports 1330 and/or 1350 may indicate an interference source, if identifiable. For example, this may include information on potential interference sources if discernable by the terrestrial network element or terminal devices. Terrestrial network element, by employing spatial interference correlation based on terminal devices feedback, may be able to identify the interference sources and report them to the NT BS 1316.

In some cases, reports 1330 and/or 1350 may indicate affected frequency bands. Specifically, the reports may indicate which central frequency bands are most affected by interference.

In some cases, reports 1330 and/or 1350 may indicate a bandwidth. Specifically, the reports may indicate an affected carrier's bandwidth.

In some cases, reports 1330 and/or 1350 may indicate Bandwidth Part (BWP) details. This may include a list of affected BWPs with relevant metrics (Start and End Frequencies, quantify how the BWP is affected (e.g., degradation in Signal-to-Noise Ratio), among other options).

In some cases, reports 1330 and/or 1350 may indicate Resource Block (RB) details. Specifically, these details may specify affected RBs with their degradation levels.

In some cases, reports 1330 and/or 1350 may indicate an aggregation technique used. This may include specifying how the feedback from multiple terminal devices was aggregated, and may include details on whether it was averaged, whether the median was taken, or any other statistical processing that was employed.

In some cases, reports 1330 and/or 1350 may indicate a temporal aggregation window, indicating a timeframe over which the feedback was aggregated.

In some cases, reports 1330 and/or 1350 may contain only a subset of the indications provided above. In some cases, reports 1330 and/or 1350 may contain other indications or information. The present disclosure is not limited to any particular information provided in reports 1330 and/or 1350.

Based on the embodiment of FIG. 13, informing NT BSs regarding the interference level of TN terminal devices and redundancy exploitation in spatial interference correlation of NTN terminal devices can enhance the accuracy and reliability of interference measurements, thereby aiding more effective interference management that can lead to adjusting a better beam hopping pattern in non-terrestrial networks.

### Combined TN and NTN Interference Aggregation

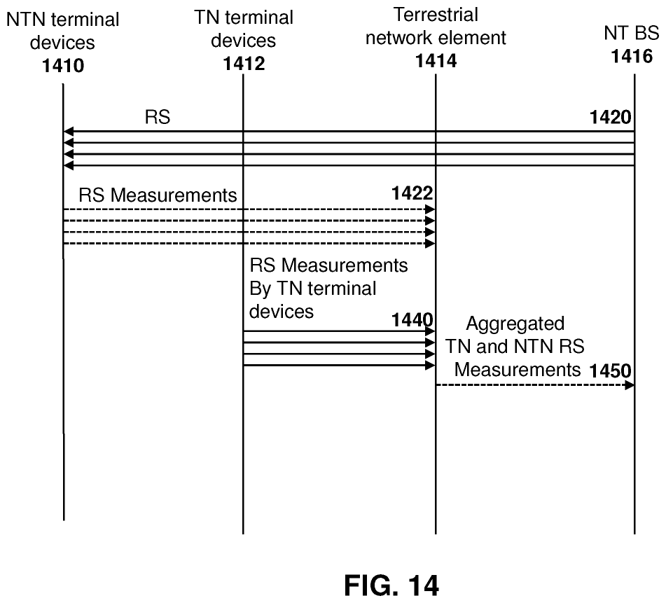

In a further embodiment similar to the embodiment of FIG. 13, the aggregated feedback report can include information from both terrestrial and non-terrestrial networks. Reference is now made to FIG. 14.

In the embodiment of FIG. 14, terrestrial network elements may be operating in the same frequency as NTN terminal devices. Further, in this embodiment, in addition to delivering the aggregated NTN terminal devices and TN terminal devices feedback separately, a network element can aggregate these feedbacks (TN and NTN) together and send them as a single aggregated message to NT BSs.

This combined feedback can provide a holistic perspective and provide insights into how NTN and TN environments interact or affect each other, facilitating integrated optimization strategies.

Furthermore, if the network requires synchronized adjustments across NTN and TN environments (for instance, if a change in one environment might impact the other), combined feedback allows decisions to consider both environments simultaneously.

Further, this type of feedback, in addition to reducing signaling overhead, can reduce the required processing time to interpret the feedback messages at NT BSs, which can lead to reducing delay and improving Quality of Service (QoS) in the network.

Thus, referring to FIG. 14, NTN terminal devices 1410 and TN terminal devices 1412 may communicate with a Terrestrial network element 1414. Further, NTN terminal devices 1410 may be serviced by NT BS 1416.

In the embodiment of FIG. 14, NT BS 1416 may send reference signals 1420 to terminal devices such as NTN terminal devices 1410.

NTN terminal devices 1410 may then process signals 1420 and provide reference signal measurements 1422 to terrestrial network element 1414.

Further, TN terminal devices 1412 may provide reference signal measurements 1440 to terrestrial network element 1414. In this case, measurements 1422 and 1440 may collectively be referred to as first messages.

Terrestrial network element 1414 may then aggregate both measurements 1422 and measurements 1440 and provide a report 1450 to NT BS 1416. Report 1450 may contain similar information to reports 1330 and 1350 from the embodiment of FIG. 13 in some cases. Thus, aggregated measurement report 1450 could include all the measurements 1422 and 1440 received, a subset of the measurements 1422 and 1440 received, information derived from reports 1422 and 1440, among other options.

Thus, according to the embodiment of FIG. 14, a combined aggregated report may be provided to NT BS 1416.

### Combined TN and NTN Interference Aggregation

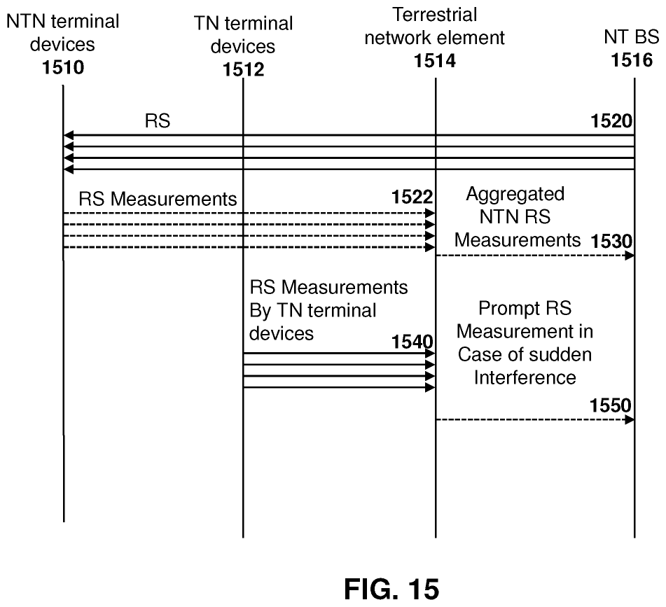

In a further embodiment similar to the embodiment of FIG. 13, sudden interference may be reported. Reference is now made to FIG. 15.

In the embodiment of FIG. 15, network elements in addition to delivering periodically the aggregated NTN terminal devices feedback, can sense the channel and receive feedback from terrestrial terminal device as well. Thus network elements can provide immediate and real-time feedback on interference. They continuously monitor the interference environment and can promptly report any changes or new interference sources. This enables faster response and adaptation to mitigate interference. If a network element experiences sudden changes in interference levels due to environmental factors or neighboring interference sources, the network element can promptly report these changes to the NTN system.

This allows the NTN system to adapt and respond quickly to varying interference conditions and optimize beam hopping or beamforming accordingly.

In general, TN feedback can be sent in various ways: periodically, aperiodically (in response to a specific request or trigger), event-driven (when a particular event or threshold is met), semi-persistent (at regular intervals, but can be altered based on certain conditions or triggers), and on-demand (only when explicitly requested by the network).

While aperiodic feedback is often initiated by a network request based on regular operational needs (like a sudden need for a Channel Quality Indicator) and on-demand feedback is more bespoke, tailored for specific scenarios or troubleshooting, event-driven feedback is autonomously generated by the terminal device itself in response to certain events or thresholds, without an explicit prior request by the network.

Thus, referring to FIG. 15, NTN terminal devices 1510 and TN terminal devices 1512 may communicate with a terrestrial network element 1514. Further, NTN terminal devices 1510 may be serviced by NT BS 1516.

In the embodiment of FIG. 15, NT BS 1516 may send reference signals 1520 to NTN terminal devices 1510.

NTN terminal devices 1510 may then process signals 1520 and provide reference signal measurements 1522 to terrestrial network element 1514.

Similar to the embodiment of FIG. 13, the measurements 1522 may be aggregated and sent as aggregated report 1530 to NT BS 1516. Aggregated report 1530 may, in some cases, contain similar information to aggregated report 1330 from the embodiment of FIG. 13.

Further, TN terminal devices 1512 may provide reference signal measurements 1540 to terrestrial network element 1514.

Terrestrial network element 1514 may then process reports 1540 (which may be referred to herein as second messages) and in the case of sudden interference, may send a message 1550 prompting RS measurements from NT BS 1516. Sudden interference may, for example, be caused by an aerial network element 740 from FIG. 7 moving into an area. Other options for sudden interference are also possible.

Thus, according to the embodiment of FIG. 15, a sudden change in the interference landscape may cause a prompt for RS measurements. This could then lead to a change in the beam hopping configuration of the NT BS.

### Reporting for Different Frequencies

In a further embodiment, the same assumptions for the system as for the embodiment of FIG. 13 may be maintained, but in the further embodiment it may be assumed that terrestrial network elements are operating in a different frequency band in comparison with NTN terminal devices.

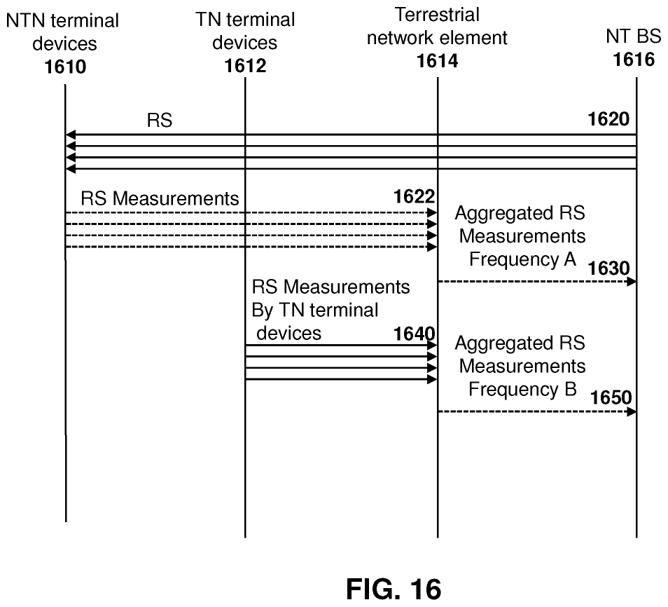

Reference is now made to FIG. 16. In the embodiment of FIG. 16, an NTN system may operate in frequency band A, while terrestrial network elements operate in frequency band B, which is different from the NTN-terminal devices'frequency band in NTN communications. While the example of FIG. 16 only shows two separate frequencies, the same techniques could be used in cases where three or more frequencies exist, and the present disclosure is thus not limited to cases with two frequencies.

The NTN system may employ beam hopping to improve performance and accommodate traffic variations. However, there are instances where terrestrial network elements operating in frequency band B experience interference from neighboring cells or external sources within their frequency band. In this case, terrestrial network elements can monitor and analyze the interference patterns within their frequency band. They can identify the specific time period and interference sources, such as neighboring cells, co-channel interference, or other external devices operating in frequency band B.

By sharing this interference information with the NTN system, the system gains insights into potential interference hotspots. The NTN system can then adjust its beam hopping pattern based on this information. It can modify the beam hopping sequences or prioritize certain beam transitions to assist TN-terminal devices located in interference hotspots.

Suppose terrestrial network elements operating in frequency B detect co-channel interference from neighboring cells or other sources within their frequency band. Although the interference is specific to frequency B, the knowledge of high interference levels or interference patterns can indicate regions or time periods of high interference activity. The NTN system can coordinate their resource allocation and adjust its beam hopping pattern in a way that during time periods or in regions where TN terminal devices experiencing high co-channel interference in frequency B, they can switch to NT BSs which are operating in frequency A in order to maintain the QoS in the network.

Thus, referring to FIG. 16, NTN terminal devices 1610 and TN terminal devices 1612 may communicate with a terrestrial network element 1614. Further, NTN terminal devices 1610 may be serviced by NT BS 1616 in frequency band A.

In the embodiment of FIG. 16, NT BS 1616 may send reference signals 1620 to NTN terminal devices 1610.

NTN terminal devices 1610 may then process signals 1620 and provide reference signal measurements 1622 to terrestrial network element 1614.

Similar to the embodiment of FIG. 13, the measurements 1622 may be aggregated and sent as aggregated report 1630 to NT BS 1616. Aggregated report 1630 may, in some cases, contain similar information to aggregated report 1330 from the embodiment of FIG. 13. Aggregated report 1630 further is specific to interference in frequency A.

Further, TN terminal devices 1612 may provide reference signal measurements 1640, which may be referred to herein as third messages, to terrestrial network element 1614.

Terrestrial network element 1614 may then process and aggregate reports 1640 and the aggregated report 1650 may be sent to NT BS 1616. Aggregated report 1650 may, in some cases, contain similar information to aggregated report 1350 from the embodiment of FIG. 13. Aggregated report 1650 further is specific to interference in frequency B.

Thus, according to the embodiment of FIG. 16, interference measurements in different frequency bands can be provided in aggregated reports to the NT BS 1616.

Further, while the implementations of FIGS. 13 to 16 provide feedback based on reference signals, in other implementations, the interference feedback to using a TN network element may be based on other signals, and the present disclosure is not limited to feedback based on reference signals.

### Scheduling

In a further embodiment, in addition to (or instead of) improving the accuracy of interference measurements, network elements can assist NT BSs during scheduling, which can lead to reducing load at the NT BS and provide an agile and flexible scheduling mechanism for NTN.

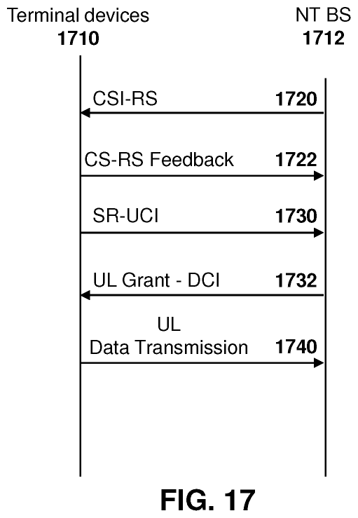

As shown in FIG. 17, currently when a terminal device 1710 needs to transmit a packet, after the terminal device is informed by NT BS 1712 regarding the beam illumination status through a beam hopping indicator signal, it needs to send a scheduling request by sending an uplink control information (UCI) to the NT BS.

In particular, NT BS 1712 may provide CSI-RS messages 1720 to terminal devices 1710, which may then provide feedback 1722 back to NT BS 1712.

The terminal device may then send a scheduling request (SR) UCI to NT BS 1712, shown with message 1730.

Then the NT BS 1712 may grant the request by sending a downlink control information (DCI) to each terminal device, indicating the scheduling decisions. This is shown with uplink (UL) grant-DCI message 1732. Message 1732 generally includes the assignment of Resource Blocks (RBs) to terminal devices, the modulation and coding scheme to be used, the number of layers for MIMO transmission, and more.

Once the terminal devices 1710 have been scheduled and assigned resources, they can start transmitting or receiving data, as shown with message 1740.

Therefore, in accordance with implementations of the present disclosure, instead of scheduling each terminal device, the NT BS may assign the overall requested resources to each beam and let the terrestrial network elements under the same beam coordinate with each other and handle the scheduling procedure.

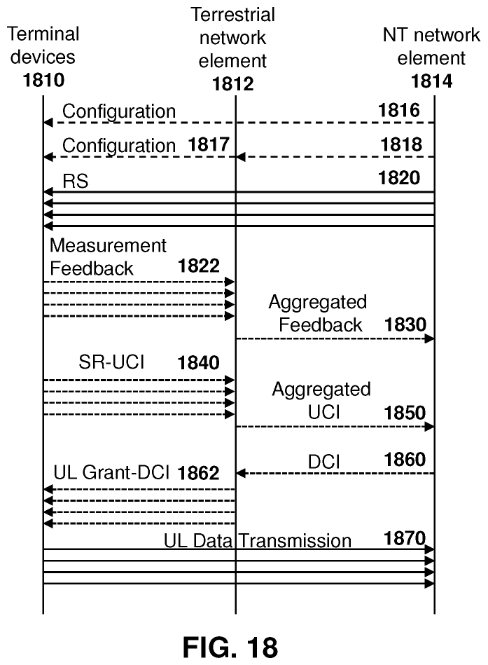

Reference is now made to FIG. 18, which shows terminal devices 1810 communicating with both a terrestrial network element 1812 and an NT BS 1814.

In the example of FIG. 18, in some cases, Terminal Devices 1810 may receive configuration messages to guide them on where to direct their feedback and/or scheduling information, whether to a NT network element such as a satellite or base station, or to a terrestrial network element, which may for example have more processing power, and could, after processing, forward messages to the NT network element. In particular, in some cases NT network element 1814 may send configuration messages 1816 to Terminal Devices 1810.

In some cases, the configuration message may be provided by Terrestrial Network element 1812 to Terminal Devices 1810, as shown with configuration message 1817 in the example of FIG. 18.

In some cases, the sending of configuration message 1817 may be based on a message 1818 from the NT network element 1814 to Terrestrial Network Element 1812. However, in other cases a different network element may prompt Terrestrial Network Element 1812 to send configuration message 1817.

Further, in addition to, or instead of, directing the Terminal Devices 1810 on where to provide feedback, configuration messages 1816 and/or 1817 may include information on how feedback should be provided, such as a frequency for providing feedback, times to provide feedback, parameters or thresholds for providing feedback, among other options. Further, configuration messages 1816 and/or 1817 may provide information on how to request uplink resources or for any scheduling information, such as directing such request through a terrestrial network element 1812.

Further, in some cases configuration messages 1816 and/or 1817 are optional, and the Terminal Devices may be pre-configured with feedback mechanisms and/or UCI parameters, for example. Other options are possible.

As with the embodiment of FIG. 13, terminal devices 1810 may receive the reference signal 1820 from NT network element 1814 and provide measurement feedback 1822 to terrestrial network element 1812.

Terrestrial network element 1812 may then provide an aggregated feedback report 1830, which may be similar to feedback report 1330 from FIG. 13.

However, for the embodiment of FIG. 18, the providing of the aggregated feedback report 1830 is optional, and in some cases the scheduling using the terrestrial network element 1812 may be done without providing interference measurements.

Terminal devices 1810 may send their UCI messages 1840 to terrestrial network elements 1812 on either PUCCH or PUSCH channels. The terrestrial network elements 1812 may then send an aggregated UCI message 1850 to NT network element 1814. Aggregated UCI message 1850 may present the overall resources requested by terminal devices.

In the embodiment of FIG. 18, when terrestrial network elements are used to assist terminal devices to send aggregated UCI messages to NT BSs, some adaptations to the UCI might be needed. The aggregated UCI may contain additional fields to convey the aggregated information from multiple terminal devices. These could be fields for aggregated CQI reports, aggregated Buffer Status Reports (BSRs), among other options, that represent a collective snapshot of the terminal devices'buffer status and channel conditions. In other cases, network elements 1812 can send the UCI messages received from multiple terminal devices as a single message to NT BSs.

Additionally, new types of UCI may in some cases be defined to support the aggregated control information. These new UCI types would need to be recognized and processed by the NT network element 1814.

Thus a new UCI format can be used by terrestrial network elements to deliver aggregated scheduling feedback on behalf of terminal devices to NT BSs.

After receiving the aggregated UCI messages 1850 sent on behalf of terminal devices 1810, which include scheduling requests, the overall Buffer Status Reports (BSRs) and channel quality metrics from network elements 1812, the NTN system makes high-level decisions about the total bandwidth, time, frequency and resources to be allocated to the corresponding beam.

The NT network element 1814 may then send this information to the network elements as a DCI 1860. To this end, when a beam is illuminated by the NT network element (e.g. NT-BS), network elements under that beam will be informed regarding the available resources and then the network elements, for example through the X2 interface, may coordinate with each other regarding their scheduling policy. Once the terrestrial network elements 1812 receive the resource allocation in DCI message 1860 from the NT BS 1814, terrestrial network elements 1812 can then proceed with more fine-grained scheduling tasks based on the received NTN terminal devices measurement feedback at the first stage.

Specifically, each terrestrial network element 1812 can distribute the resources among its associated terminal devices 1810 based on various factors such as QoS requirements, priority levels, traffic load, channel conditions, etc. The terrestrial network element then sends the scheduling grants to terminal devices on the Physical Downlink Control Channel (PDCCH), shown with message 1862, by sending the DCI on behalf of the NT network element, which include details such as allocated RBs, timing, power, and modulation and coding scheme. However, to ensure terminal devices correctly understand that these resources are assigned by the NT network element and not the terrestrial network element, in some cases modifications may need to be made to the DCI format or additional signaling may be used.

One way to achieve this is to use a unique identifier in the DCI that differentiates between NT BS and terrestrial allocations. The terminal devices 1810 would need to be programmed to understand this identifier and interpret the DCI accordingly.

Another approach might involve the use of distinct carrier frequencies for terrestrial and NT communication, so the terminal devices would know which entity is assigning resources based on the frequency of the received control channel.

Other options are possible.

Thus a new DCI format can let terrestrial network elements assist NT BSs during scheduling procedure and let terrestrial network elements schedule NTN terminal devices on behalf of NT network elements.

Terminal devices 1810 may then use the allocated resources to perform uplink data transmissions 1870 to the NT network element 1814.

As will be appreciated by those skilled in the art, the scheduling of the embodiment of FIG. 18 may further have some terminal devices still providing scheduling requests directly to the NT network element (for example such terminal devices may be outside of the terrestrial network element coverage, or may be devices that cannot communicate with a terrestrial network element, among other factors).

In some cases, various terrestrial network elements can coordinate with each other and one terrestrial network element can send the aggregated UCI message 1850 on behalf of several terrestrial network elements for a plurality of NTN terminal devices.

Other variations are possible.

The approach of FIG. 18 allows for a more efficient use of the NT BS's resources by leveraging the terrestrial network's closer proximity to the terminal devices and its potentially superior capability to handle fine-grained scheduling tasks. Additionally, the embodiment of FIG. 18 can reduce the signaling load on the NT BS, as the high-frequency scheduling exchanges are handled by the terrestrial network.

However, in some cases, the non-terrestrial network may be used for aggregating messages, and the present disclosure is not limited to the examples of FIGS. 10 to 18 above. Thus, the implementations of FIGS. 10 to 18 could provide feedback from a terminal device to an NT network element, which may then aggregate the feedback and provide a message to a terrestrial network element. Other options are possible.

The solutions described in the disclosure are applicable to a next generation (e.g. sixth generation (6G) or later) network, or a legacy (e.g. 5G, 4G, 3G or 2G) network.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

It could be noted that the message in the disclosure could be replaced with information, which may be carried in one single message, or be carried in more than one separate message.

Without special noting, the terms “apparatus” and “device” are used interchangeably, and the terms “identity” and “identifier” are used interchangeably.

In the disclosure, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

In the disclosure, the words “first”, “second”, etc., when used before a same term (e.g., ED, or an operating step) does not mean an order or a sequence of the term. For example, the “first ED” and the “second ED”, means two different EDs without specially indicated, and similarly, although the present disclosure describes methods and processes with steps in a certain order, one or more steps of the methods and processes may be omitted or altered as appropriate. One or more steps may take place in an order other than that in which they are described, as appropriate. For example, the “first step” and the “second step” means two different operating steps without specially indicated, but does not mean the first step has to happen before the second step. The real order depends on the logic of the two steps.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The present disclosure encompasses various implementations, including not only method implementations, but also other implementations such as apparatus implementations and implementations related to non-transitory computer readable storage media. Implementations may incorporate, individually or in combinations, the features disclosed herein.

The term “receive”, “detect” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detects and decodes it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decode the paging. “paging is not received” means the receiving side tries to detect and/or decode the paging, but does not obtain the paging successfully. The term “receive” may sometimes indicate that a signal arrives at the receiving side, but does not mean the information in the signal is detected and decoded correctly, then the receiving side needs to perform detecting and decoding on the signal to obtain the information carried in the signal. In this scenario, “receive”, “detect” and “decode” may indicate different procedures at the receiving side to obtain the information.

“Subset” of a collection in this disclosure means some or all elements in the collection.

Although this disclosure refers to illustrative implementations, this is not intended to be construed in a limiting sense. Various modifications and combinations of the illustrative implementations, as well as other implementations of the disclosure, will be apparent to persons skilled in the art upon reference to the description. When combining two or more implementations, not all the features in the implementations to be combined are necessary for the combination.

Features disclosed herein in the context of any particular implementations may also or instead be implemented in other implementations. Method implementations, for example, may also or instead be implemented in apparatus, system, and/or computer program product implementations. In addition, although implementations are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and implementations thereof, various modifications and combinations can be made thereto without departing from the invention. The description and drawings are, accordingly, to be regarded simply as an illustration of some implementations of the invention as defined by the appended claims, and are contemplated to cover any and all modifications, variations, combinations or equivalents that fall within the scope of the present invention. Therefore, although implementations and potential advantages have been described in detail, various changes, substitutions and alterations can be made herein without departing from the invention as defined by the appended claims. Moreover, the scope of the present application is not intended to be limited to the particular implementations of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding implementations described herein may be utilized according to the present invention. Accordingly, the appended claims are intended to include within their scope such processes, machines, manufacture, compositions of matter, means, methods, or steps.

What is claimed is:

1. A method at a first network element, the first network element being a terrestrial network element, and the method comprising:
receiving first messages from terminal devices; and
sending an aggregated message to a second network element, the aggregated message indicating one or both of: a subset of the first messages and information derived from the first messages,
wherein the second network element is a non-terrestrial network element.

2. The method of claim 1, wherein each of the first messages comprises interference measurements based on at least one of: a quality of a communications channel or reference signals,
wherein the aggregated message comprises aggregated interference measurements.

3. The method of claim 1, further comprising:
removing outliers from the first messages.

4. The method of claim 1, wherein the aggregated message further includes at least one of: an identifier of the first network element; an aggregated channel quality indicator (CQI); an aggregated rank indicator (RI); an aggregated precoding matrix indicator (PMI); an aggregated reference signal received power (RSRP) and reference signal received strength indicator (RSSI); an interference level; an interference source;
an affected frequency band; a bandwidth; bandwidth part details; resource block details;
an aggregation technique; or a temporal aggregation window.

5. The method of claim 2, wherein a subset of the first messages includes interference measurements based on at least one of the reference signals or a quality of a communications channel, as reported from terrestrial network terminal devices, and a further subset of the first messages includes interference measurements based on at least one of the reference signals or the quality of a communications channel, as reported from non-terrestrial network terminal devices, and wherein the aggregated message includes information from both the terrestrial network terminal devices and non-terrestrial network terminal devices.

6. The method of claim 1, further comprising:
receiving second messages from one or more of the terminal devices, wherein the one or more of the terminal devices are served by the first network element;
detecting a change in interference measurements based on the second messages; and
providing a report to the second network element based on the change in interference measurements.

7. The method of claim 1, wherein each of the first messages comprises an uplink scheduling request for non-terrestrial terminal devices, and wherein the aggregated message comprises uplink control information (UCI) indicating the uplink scheduling requests.

8. An apparatus in a first network element, the apparatus comprising:
at least one processor coupled with a non-transitory computer-readable medium storing instructions, wherein when the instructions are executed by the at least one processor, the apparatus is caused to:
receive first messages from terminal devices; and
send an aggregated message to a second network element, the aggregated message indicating one or both of: a subset of the first messages and information derived from the first messages,
wherein the first network element is a terrestrial network element and the second network element is a non-terrestrial network element.

9. The apparatus of claim 8, wherein each of the first messages comprises interference measurements based on at least one of: a quality of a communications channel or reference signals,
wherein the aggregated message comprises aggregated interference measurements.

10. The apparatus of claim 8, wherein the apparatus is further caused to:
remove outliers from the first messages.

11. The apparatus of claim 8, wherein the aggregated message further includes at least one of: an identifier of the first network element; an aggregated channel quality indicator (CQI); an aggregated rank indicator (RI); an aggregated precoding matrix indicator (PMI); an aggregated reference signal received power (RSRP) and reference signal received strength indicator (RSSI); an interference level; an interference source; an affected frequency band; a bandwidth; bandwidth part details; resource block details; an aggregation technique; or a temporal aggregation window.

12. The apparatus of claim 9, wherein a subset of the first messages includes interference measurements based on at least one of the reference signals or a quality of a communications channel, as reported from terrestrial network terminal devices, and a further subset of the first messages includes interference measurements based on at least one of the reference signals or the quality of a communications channel, as reported from non-terrestrial network terminal devices, and wherein the aggregated message includes information from both the terrestrial network terminal devices and non-terrestrial network terminal devices.

13. The apparatus of claim 8, wherein the apparatus is further caused to:
receive second messages from one or more of the terminal devices, wherein the one or more of the terminal devices are served by the first network element;
detect a change in interference measurements based on the second messages; and
provide a report to the second network element based on the change in interference measurements.

14. The apparatus of claim 8, wherein each of the first messages comprises an uplink scheduling request for non-terrestrial terminal devices, and wherein the aggregated message comprises uplink control information (UCI) indicating the uplink scheduling requests.

15. A non-transitory computer readable medium for storing instructions, which, when executed by an apparatus in a first network element, cause the apparatus to:
receive first messages from terminal devices; and
send an aggregated message to a second network element, the aggregated message indicating one or both of: a subset of the first messages and information derived from the first messages,
wherein the first network element is a terrestrial network element and the second network element is a non-terrestrial network element.

16. The non-transitory computer readable medium of claim 15, wherein each of the first messages comprises interference measurements based on at least one of: a quality of a communications channel or reference signals,
wherein the aggregated message comprises aggregated interference measurements.

17. The non-transitory computer readable medium of claim 15, wherein when the instructions are executed by the apparatus, the apparatus is further caused to:
remove outliers from the first messages.

18. The non-transitory computer readable medium of claim 15, wherein the aggregated message further includes at least one of: an identifier of the first network element; an aggregated channel quality indicator (CQI); an aggregated rank indicator (RI); an aggregated precoding matrix indicator (PMI); an aggregated reference signal received power (RSRP) and reference signal received strength indicator (RSSI); an interference level; an interference source; an affected frequency band; a bandwidth; bandwidth part details; resource block details; an aggregation technique; or a temporal aggregation window.

19. The non-transitory computer readable medium of claim 16, wherein a subset of the first messages includes interference measurements based on at least one of the reference signals or a quality of a communications channel, as reported from terrestrial network terminal devices, and a further subset of the first messages includes interference measurements based on at least one of the reference signals or the quality of a communications channel, as reported from non-terrestrial network terminal devices, and wherein the aggregated message includes information from both the terrestrial network terminal devices and non-terrestrial network terminal devices.

20. The non-transitory computer readable medium of claim 15, wherein when the instructions are executed by the apparatus, cause the apparatus further to:
receive second messages from one or more of the terminal devices, wherein the one or more of the terminal devices are served by the first network element;
detect a change in interference measurements based on the second messages; and
provide a report to the second network element based on the change in interference measurements.
